(19) United States
(12) Patent Application Publication
(10) Pub. No.: US 2026/0016590 A1
(43) Pub. Date: Jan. 15, 2026

(54) Channel Estimation for Locating RFID Tags

(71) Applicant: Automaton, Inc., San Diego, CA (US)

(72) Inventors: Spencer Hewett, New York, NY (US); Melissa Swats, Boca Raton, FL (US); Stewart Webb, Anaheim Hills, CA (US); Debarun Dhar, New York, NY (US); Joe Mueller, San Diego, CA (US); Paul Petrus, San Jose, CA (US)

(73) Assignee: Automaton, Inc., San Diego, CA (US)

(21) Appl. No.: 19/329,829

(22) Filed: Sep. 16, 2025

Related U.S. Application Data
(63) Continuation of application No. PCT/US2024/020357, filed on Mar. 18, 2024.
(60) Provisional application No. 63/490,836, filed on Mar. 17, 2023.
(60) Provisional application No. 63/603,892, filed on Nov. 29, 2023.

(51) Int. Cl. G01S 13/75; G06K 7/10

(52) U.S. Cl. CPC G01S 13/751; G06K 7/10128

(57) ABSTRACT

When a radio-frequency identification (RFID) tag reader queries an RFID tag, the reader or an appliance coupled to the reader derives a channel estimate from the tag's reply to the reader's query. The channel estimate represents the communications channel between the reader and that tag—or more precisely between the reader and the tag's location. This channel estimate acts as a fingerprint or signature for the communications channel between the reader and the tag's location. If the tag's environment is relatively static, then the channel estimate should be relatively stable, even if the tag is moved. The reader or appliance creates a library of tag locations indexed by channel estimate for each tag within range of the reader. When the reader receives a reply from a tag at an unknown location, the reader or appliance computes the corresponding channel estimate and uses that channel estimate to look up the closest location in the library of tag locations.

### CROSS REFERENCE TO RELATED APPLICATIONS

This application is a bypass continuation of International Application No. PCT/US2024/020357, filed Mar. 18, 2024, which claims the priority benefit, under 35 U.S.C. 119 (c), of U.S. Application No. 63/603,892, filed Nov. 29, 2023, and of U.S. Application No. 63/490,836, filed Mar. 17, 2023. Each of these applications is incorporated herein by reference in its entirety for all purposes.

### BACKGROUND

Radio-frequency identification (RFID) tags, or tags, are low-cost devices that can be attached to objects and offer the promise of automated tracking, locating, sales check-out, and inventory of the objects among other commercial and medical applications. There are passive, semi-active, and active types of RFID tags that can be wirelessly interrogated by an RFID tag reader, also called a reader, interrogator, or sensor, and emit wireless radio-frequency (RF) replies to the reader. Each reply can include information stored in the RFID tag, such as an electronic product code (EPC), tag identification number, or other alpha-numeric sequence. Other information may be included with the reply. Each EPC is unique and so can be used to identify the tag that sent a particular reply.

Passive RFID tags have no battery and are therefore typically less expensive than semi-active and active RFID tags. A passive RFID tag is powered by an unmodulated, continuous-wave (cw) RF signal from the RFID tag reader. This cw RF signal powers up the passive RFID tag's circuitry and precedes a query or command from the RFID tag reader in the form of a modulated RF signal. The passive RFID tag receives and demodulates the modulated RF signal and responds to the RFID tag reader by modulating and backscattering a portion of the modulated RF signal. This modulated, backscattered RF signal is the passive RFID tag's reply and is at the same carrier frequency as the RF signal from the RFID tag reader. The replies from passive RFID tags are detected by the RFID tag readers and are typically many orders of magnitude weaker than the RF signals from the RFID tag readers.

Each cycle of transmitting a continuous-wave RF signal at a given carrier frequency from the sensor to the tag and receiving the tags' replies at the same carrier frequency at the sensor is called a hop. The sensor can transmit one or more commands or queries during a hop. A single sensor can also repeat hops periodically, at different carrier frequencies, until it has read all of the tags within range. For ultrahigh frequency (UHF) passive RFID tags, the carrier frequencies are typically within bands of 865-868 MHZ (Europe) or 902-928 MHZ (North America). The sensor can continue to query the tags within range periodically, for example, to monitor inventory of objects affixed to the tags.

Sensors can also be used to estimate a tag's location in two or three dimensions using one of several techniques. For instance, a sensor may measure the amplitude or power of the tag's reply in addition to the unique modulation (e.g., encoding the EPC) that identifies which tag is replying to the query. If the sensor has an antenna array, it can sense the angle-of-arrival (AOA) of the tag's reply in addition to or instead of the received signal strength indicator (RSSI) or other measurement of the detected signal power or amplitude. A computer, controller, or appliance coupled to the sensors can use the RSSIs and/or AOAs to estimate the tag's position in two or three dimensions. If the appliance knows or assumes the tag's position in one dimension (e.g., height), the appliance can estimate the tag's location in three dimensions from a single AOA estimate (e.g., by computing the position at which the AOA intersects a plane at a given height).

### SUMMARY

In practice, scattering, fading, interference, and other effects degrade the communications channels or links between the tags and the sensors, making it more difficult to accurately locate an RFID tag based on RSSIs or AOAs. But these effects can be exploited to locate an RFID tag quickly and accurately based on detection of a single reply by a single sensor. This is because scattering, fading, interference, and other effects are functions of tag position, tag orientation, sensor position, carrier frequency, and sensor antenna configuration (e.g., the sensor beamforming sector, or simply sector) and affect each communications channel differently. These effects can be characterized by channel estimates, parameterized by sensor, carrier frequency, sensor beamforming sector, interrogation signal amplitude, and/or other degrees of freedom associated with the interrogation signal, for each communications channel.

If each channel estimate is unique and the communications channels remain relatively static and independent of the individual tags' characteristics, then a channel estimate can be used as a fingerprint that identifies the corresponding communications channel. And if the locations of the endpoints of each communications channel—i.e., the locations of the sensor and tag—are known, then the channel estimate can be mapped to those locations. In other words, for each sensor, a unique channel estimate for each set of parameters can be assigned to the location of each tag within range of that sensor.

The sensor and/or an appliance or controller coupled to the sensor can store the channel estimates, parameters associated with the channel estimates, noise properties associated the communications channel and/or parameters, electronic product codes (EPCs) or other tag identifiers, and optionally tag locations in one or more lookup tables (LUTs) or other data stores, with the channel estimates and associated parameters acting as keys or indices for the slots in the LUT that store the tag locations. Whenever a sensor detects a reply from a tag, the sensor (and/or an appliance communicatively coupled to the sensor) derives the channel estimate from the detected reply for the communications channel between the sensor and tag and uses the channel estimate to look up the corresponding tag location in the LUT. If the LUT does not include an identical entry, then the sensor (or the appliance) may estimate the tag's position from the closest entry or entries in the LUT. Deriving the channel estimate based on a single reply detected by a single sensor and looking up the corresponding location in the LUT can be accurate enough for most purposes (and possibly faster and more accurate than locating a tag from AOA or RSSI measurements based on a single reply detected by a single sensor).

The sensor and appliance can also work in an efficient, scalable, distributed fashion to identify and locate RFID tags. In this approach, each sensor stores a LUT that includes channel estimates and electronic product codes (EPCs) or other identifiers for the tags within range, and the appliance stores a LUT with locations indexed by EPC. When a sensor receives a reply from a tag, it computes the current channel estimate based on the reply, carrier frequency, etc. The sensor compares the current channel estimate for the tag (EPC) to the most recent channel estimate stored in the LUT for that EPC. If the current channel estimate matches the most recent channel estimate (e.g., to within an acceptable threshold), then the sensor reports that the tag has not moved to the appliance, which in turn looks up and returns the tag's most recent location, e.g., from its LUT. If the current and most recent channel estimates do not match, or if the sensor's LUT does not store any channel estimates for the tag, then the sensor reports that the tag has moved or is new to the appliance. In this case, the sensor may also report the EPC of the tag with the closest channel estimate in the sensor's LUT and/or AOA, RSSI, or other information derived from the tag's reply to the appliance. The appliance can use this information to estimate the (new) tag's location.

The sensor (or an appliance or controller coupled to the sensor) can store the mean or average channel estimate, all channel estimates, and/or noise properties (e.g., standard deviation among the channel estimates) for a given set of parameters for each communications channel within range (tag/sensor pair). If the corresponding tag's location is known, the appliance can map this channel estimate information to the tag's x, y, and z coordinates. If the tag's position is not known, the appliance can estimate the tag's position using methods such as AOA combined with outliers detection. Each sensor's LUT stores the average or series of channel estimates and possibly other information, such as standard deviations in the channel estimates, for a selection of tags, with each channel estimate corresponding to an xyz location of a tag.

Unless the environment changes, the channel estimate/location mapping generally remains valid even if the tag originally used to generate the channel estimate has moved. As a result, it is possible to record a channel estimate for any tag, at a known position and orientation at a given time, and then leverage that channel estimate to locate a different tag at the same position and orientation at a different (e.g., earlier or later) time. It also means that the appliance can record a channel estimate for a tag at an unknown location, then estimate the tag's location based on other information, such as AOA measurements, imagery, or channel estimates for tags at known locations, and assign the channel estimate to the location estimate at a later time.

A method of locating RFID tags based on channel estimates can be carried out as follows. An RFID tag reader detects a reply from a first RFID tag. This reply is used to form a first channel estimate that represents a communications channel between the RFID tag reader and the first RFID tag at a carrier frequency of the reply from the first RFID tag. The location of the first RFID tag is determined, e.g., based on an AOA derived from the reply or from an image of the first RFID tag and an object or person acquired by a camera. The location of the first RFID tag can also be associated with the first channel estimate based on an electronic product code (EPC) encoded in the reply from the first RFID tag. The RFID tag reader detects a reply from a second RFID tag. (If desired, the first RFID tag can be moved after the RFID tag reader detects the reply from the first RFID tag and before detecting the reply from the second RFID tag.) This reply is used to form a second channel estimate that represents a communications channel between the RFID tag reader and the second RFID tag. The first and second channel estimates are compared, and this comparison, together with the location of the first RFID tag, is used to estimate a location of the second RFID tag. (If desired, the sensor can make and average multiple measurements of the first channel estimate and, independently, the second channel estimate to reduce noise.)

Comparing the first and second channel estimates may include finding a Euclidean distance (in a complex, multi-dimensional channel estimate space) between the first channel estimate and the second channel estimate. This Euclidean distance can be compared to a predetermined threshold; if the Euclidean distance falls below the predetermined threshold, then the first and second channel estimates are close enough to each other for the locations of the first and second RFID tags to be highly correlated (i.e., for the first and second RFID tags to be close to each other in real space).

The location of the first RFID tag can be stored in a lookup table (LUT) or other data store indexed by the first channel estimate or by the EPC of the first RFID tag, in which case estimating the location of the second RFID tag comprises retrieving the location of the first RFID tag from the LUT based on the comparison. The LUT can store locations of other RFID tags indexed by channel estimates as well. For instance, the LUT can store the location and (third) channel estimate of a third RFID tag. The third channel estimate is based on the reply from the third RFID tag detected by the RFID tag reader and represents a communications channel between the RFID tag reader and the third RFID tag. It can be compared to the other channel estimates in the LUT. The comparison of these channel estimates can be used to determine that the location of the second RFID tag is closer to the location of the first RFID tag than to the location of the third RFID tag.

An inventive system for locating radio-frequency identification (RFID) tags may include one or more RFID tag readers (also known as tag readers, readers, or sensors) and an appliance (also known as a central controller or interrogator controller) operably coupled to the readers. In operation, the RFID tag reader detects a reply from a first RFID tag, forms a first channel estimate based on the reply from the first RFID tag, detects a reply from a second RFID tag, forms a second channel estimate based on the reply from the second RFID tag, and compares the first and second channel estimates. The appliance estimates a location of the first RFID tag based on the reply from the first RFID tag, receive the comparisons of the first and second channel estimates, and estimates, based at least in part on the comparison and on the location of the first RFID tag, a location of the second RFID tag. The reply from the first RFID tag encodes an electronic product code (EPC) of the first RFID tag and the RFID tag reader can store the first channel estimate associated with the EPC of the first RFID tag in a lookup table.

The RFID tag reader may include an antenna array with n antenna elements, where n is an integer greater than 1, and a processor operably coupled to the antenna array. The antenna elements in the antenna array sense radiation from the first and second RFID tags. And the processor generates, for each antenna element, a complex number representing a phase and an amplitude of the reply as detected at that antenna element.

The appliance can estimate the location of the first RFID tag based on an angle of arrival of the reply from the first RFID tag at the RFID tag reader. Alternatively, the appliance can estimate the location of the first RFID tag based on a correlation of a location of an object or person appearing in an image with the first RFID tag.

The RFID tag reader can perform the comparison of the second channel estimate to the first channel estimate by finding a Euclidean distance between the first channel estimate and the second channel estimate. The RFID tag reader can compare the Euclidean distance to a predetermined threshold.

The appliance may include a memory and a processor operably coupled to the memory. In operation, the memory can store the location of the first RFID tag in a lookup table indexed by the first channel estimate. And the processor can retrieve the location of the first RFID tag from the lookup table based on the comparison of the second channel estimate to the first channel estimate.

The RFID tag reader can also detect a reply from a third RFID tag, form a third channel estimate based on the reply from the third RFID tag, and perform a comparison of the second and third channel estimates. In such an example, the appliance can estimate a location of the third RFID tag based on the reply from the third RFID tag, store the location of the third RFID tag in the lookup table indexed by the third channel estimate, and determine, based on the comparison of the second and third channel estimates, that the location of the second RFID tag is closer to the location of the first RFID tag than to the location of the third RFID tag.

Another embodiment of the present technology includes a method of locating an RFID tag that includes detecting, by an RFID tag reader, a reply from the RFID tag at a first carrier frequency and a first beamforming sector. The RFID tag reader forms a channel estimate based on the reply from the RFID tag and compares it to previously determined channel estimates based on replies detected by the RFID tag reader using the first beamforming sector and/or at the first carrier frequency. The RFID tag reader and/or an appliance estimate a location of the RFID tag based on a previously determined location associated with one of the previously determined channel estimates.

The previously determined channel estimates may be associated with the RFID tag, in which case comparing the channel estimate to the previously determined channel estimates comprises retrieving the previously determined channel estimates from a memory of the RFID tag reader based on an identifier (e.g., an EPC) of the RFID tag encoded in the reply. The RFID tag reader compares the channel estimate to the previously determined channel estimates. If the channel estimate is within a predetermined threshold of the one of the previously determined channel estimates, the RFID tag reader and/or an appliance estimate the location of the RFID tag to be the previously determined location associated with the one of the previously determined channel estimates. The RFID tag reader can store previously determined locations associated with the previously determined channel estimates in its memory, e.g., indexed by the previously determined channel estimates and/or by electronic product codes of the RFID tags.

Yet another inventive method of locating a (first) RFID tag includes detecting, by an RFID tag reader, replies from RFID tags at each of a plurality of carrier frequencies and forming respective channel estimates for the RFID tags at each of the plurality of carrier frequencies. The RFID tag reader or an appliance coupled to the RFID tag reader stores respective locations of the RFID tags indexed by the respective channel estimates in a memory. The RFID tag reader detects a reply from the first RFID tag at a first carrier frequency in the plurality of carrier frequencies and forms a first channel estimate for the first RFID tag at the first carrier frequency based at least in part on the reply from the first RFID tag at the first carrier frequency. The RFID tag reader and/or appliance determine a closest channel estimate to the first channel estimate from among the respective channel estimates stored in the memory, estimate a location of the first RFID tag to be a location corresponding to the closest channel estimate, and retrieve the location corresponding to the closest channel estimate from the memory.

Other embodiments of the present technology include methods of detecting motion using RFID tags. One such method includes using an RFID tag reader to detect a first reply from an RFID tag at a first time. The RFID tag reader forms a first channel estimate for a communications channel between the RFID tag and the RFID tag reader based on the first reply. At a second time after the first time, the RFID tag reader detects a second reply from the RFID tag and forms a second channel estimate for the communications channel between the RFID tag and the RFID tag reader based on the second reply. The RFID tag reader or an appliance coupled to the RFID tag reader determines that the second channel estimate differs from the first channel estimate by more than a predetermined amount, indicating that motion has affected the communications channel. This motion can be movement of the RFID tag, a person, and/or an object other than the RFID tag. If the RFID tag has moved, then the RFID tag reader and/or appliance can determine first and second estimated locations for the RFID tag based on the first and second channel estimates, respectively.

Another inventive method of detecting motion includes detecting changes in communications channels between a first and second RFID tags and an RFID tag reader and determining, based on the changes in the communications channels, that motion has occurred in an area encompassing at least a portion of the communications channels. Detecting the change in the communications channel(s) can include detecting a change in relative phase of radio-frequency radiation received by antenna elements of the RFID tag reader from the first or second RFID tag. The RFID tag reader may form channel estimates for other RFID tags and/or switch operating modes in response to determining that motion has occurred.

Yet another embodiment includes a system for locating an RFID tag with an RFID tag reader and a controller. The RFID tag reader determines a channel estimate of a communications channel between the RFID tag reader and the RFID tag, performs a comparison of the channel estimate to a previously determined channel estimate for the RFID tag, and determines whether or not the RFID tag moved since the RFID tag reader determined the previously determined channel estimate. The controller, which is operably coupled to RFID tag reader, receives an identifier for the RFID tag (e.g., an EPC) and an indication of whether or not the RFID tag moved from the RFID tag reader and estimates a location of the RFID tag based on the identifier and the indication. The controller can store previously determined locations for a plurality of RFID tags indexed by identifiers of the plurality of RFID tags in a memory.

Still another embodiment includes a method of locating an first RFID tag as follows. An RFID tag reader determines a channel estimate for a communications channel between the RFID tag reader and the first RFID tag and performs a comparison of the channel estimate to a previously determined channel estimate for the first RFID tag. If the channel estimate is within a threshold of the previously determined channel estimate, the RFID rag reader and/or an appliance operably coupled to the RFID tag reader estimate a location of the first RFID tag to be a previously estimated location for the first RFID tag. And if the channel estimate is more than the threshold away from the previously determined channel estimate, the RFID rag reader and/or appliance can determine that the channel estimate is within the threshold of a previously determined channel estimate for a second RFID tag and identify the location of the first RFID tag be a previously estimated location of the second RFID tag.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A depicts an environment, such as a store or warehouse, depicting communications channels between RFID tags and several RFID tag readers in an RFID tag location system.

FIG. 1B illustrates an RFID tag reader suitable for use in the RFID environment of FIG. 1A.

FIG. 1C illustrates an appliance suitable for controlling RFID tag readers in the RFID environment of FIG. 1A.

FIG. 2 illustrates a process for deriving channel estimates for pairs of RFID tags and RFID tag readers and using the channel estimates to locate other RFID tags.

FIG. 3A illustrates a signature creation/formation mode for an RFID tag location system that uses channel estimates for locating RFID tags.

FIG. 3B illustrates a signature exploitation/consumption mode for an RFID tag location system that uses channel estimates for locating RFID tags.

FIG. 4A illustrates a process for populating a lookup table (LUT) with channel estimates and angles of arrival (AOAs) derived from RFID tag replies, using detected channel estimates and electronic product codes (EPCs) to determine if a tag has moved, and reporting EPCs, AOAs, and motion detection based on comparisons of detected channel estimates to channel estimates stored in the LUT.

FIG. 4B illustrates a process for estimating the location of a tag based on the EPCs, AOAs, and motion detected reported using the process in FIG. 4A.

FIG. 5A illustrates how sensors can detect changes in channel estimates for a tag caused by movement of that tag.

FIG. 5B illustrates how multiple sensors can distinguish changes in channel estimates caused by changes in the environment from changes in channel estimates caused by tag movement.

FIG. 6 is a box plot of signature (channel estimate) distances versus physical distances for RFID tags measured with different parameters (sensors, carrier frequencies, and beamforming sectors).

### DETAILED DESCRIPTION

A channel estimate models the effect of propagation along a communications channel between an RFID tag, or tag, and an RFID tag reader, or sensor, on a signal at a particular carrier frequency. Put differently, if the communications channel acts as a filter, then the channel estimate can be thought of as the communications channel's transfer function. A channel estimate between an antenna element and a tag can be represented as a single complex number. A channel estimate between an antenna array with multiple antenna elements can be represented as an array of complex numbers-one complex number per antenna element-due to the physical separation between the antenna elements. For a sensor with a four-element array, the channel estimate can be represented as four complex numbers.

The real and imaginary portions of the complex numbers associated with the different antenna elements represent the relative amplitudes and phases, respectively, of the signal as detected by the different antenna elements. Changes in communications channels can produce both amplitude and phase changes, but the amplitude changes tend to be roughly the same for each antenna element in the sensor. Noise can make relative amplitude changes difficult to detect. Conversely, phase changes tend to be different for each transmit (Tx) and receive (Rx) channel (antenna element) and are less susceptible to noise. Thus, a sensor with multiple antenna elements (Rx streams) can usually detect changes in communications channels, for example, due to motion as described below, more reliably than a sensor or receiver with only antenna element (Rx stream).

The channel estimate for each sensor/tag pair can be mapped or assigned to the tag's EPC and/or location and correlated with channel estimates for other tags that communicate with the same sensor. A strong correlation (e.g., within a given percentage of 1) indicates that the tags associated with the different channel estimates are at or near the same location. This means that channel estimates for tags at known locations can be used to estimate locations of other tags quickly and accurately based on the channel estimates of those other tags as described in greater detail below.

Locating RFID tags using channel estimates offers several advantages over other RFID tag location techniques, including insensitivity to implementation issues in the data path processing that occur leading up to channel estimation. These issues may include but are not limited to errors in the array manifold (e.g., mismatch between the antenna model used to form the array manifold and the actual physical antenna) for angle-of-arrival determination, quantization errors, and so on. Channel estimate-based RFID location techniques should be more tolerant of errors or imperfections in factory calibration as well as stationary processes that cause imperfections or other problems in the signal path up to the communications channel. They can also tolerate errors that are functions of the RFID tag itself, so long as those errors manifest in a consistent, detectable manner and the channel estimate can be characterized appropriately.

### Channel Estimates for RFID Tag/RFID Tag Reader Pairs

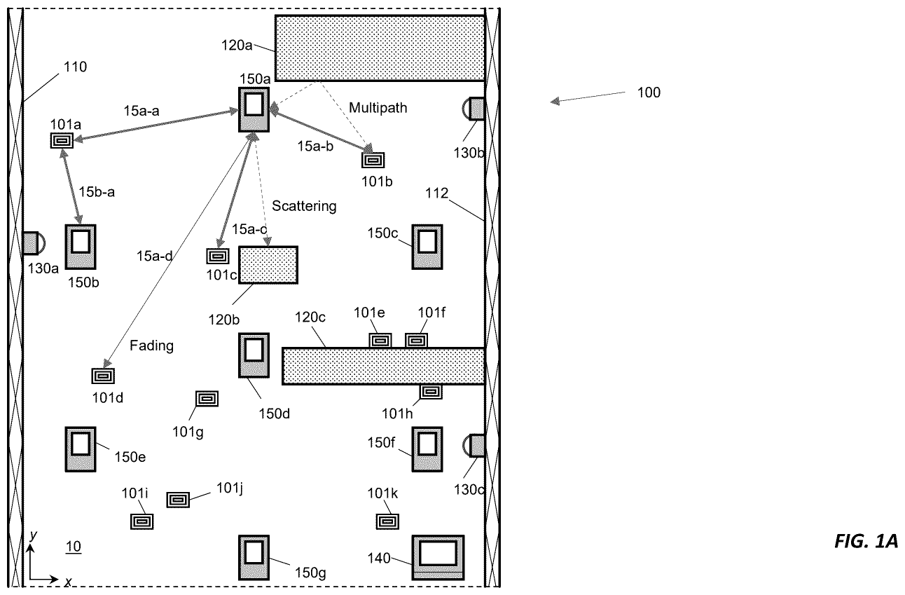

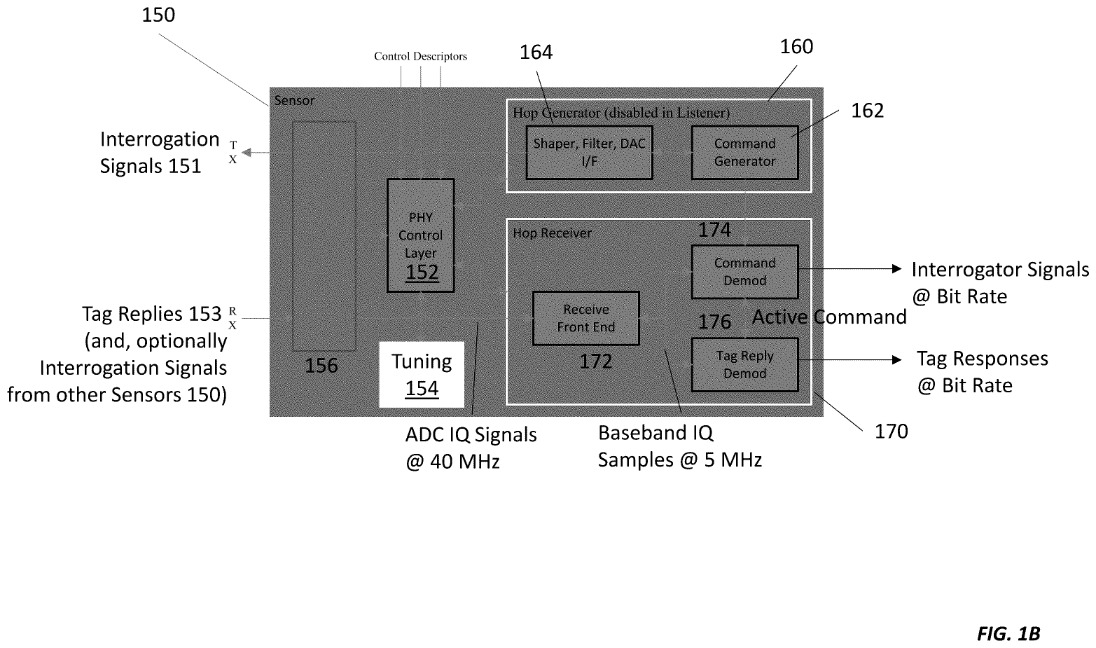

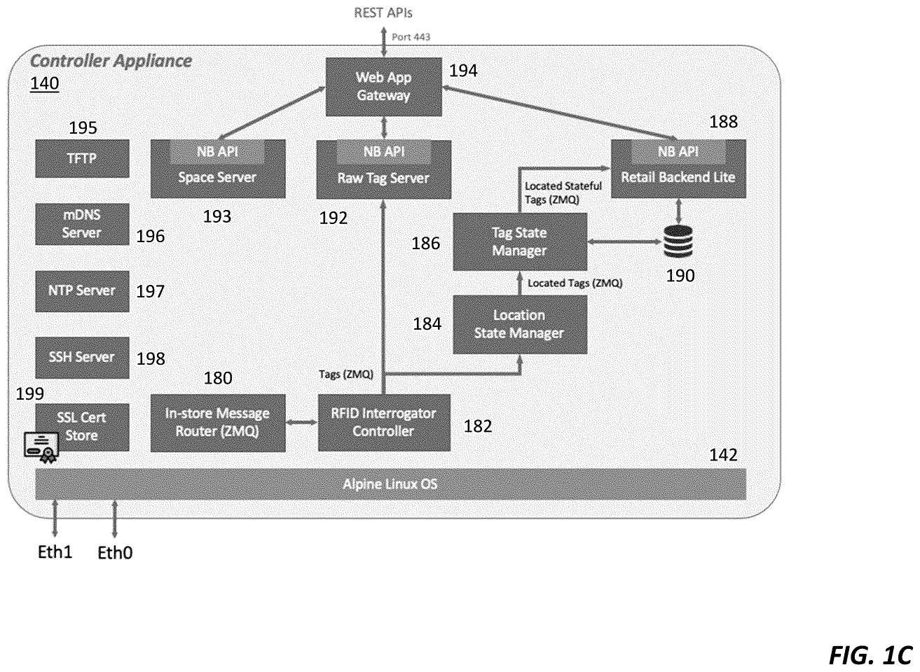

FIG. 1A depicts an RFID tag location system 100 that locates passive RFID tags 101a-101k (collectively, RFID tags 101), or tags, in an environment 10, such as a retail store or warehouse, using channel estimates. The RFID tag location system 100 includes RFID tag readers 150a-150g (collectively, RFID tag readers 150), also called readers or sensors, that transmit interrogation signals to the tags 101 and detect replies from the tags 101; an interrogator controller or appliance 140 that is coupled to the sensors 150 (e.g., via wireless or wired connections); and optional cameras 130a-130c (collectively, cameras 130) that can be used to confirm the tags' locations, e.g., for mapping channel estimates to particular locations in the environment 10. The sensors 150 determine channel estimates based on the replies and use them to determine whether a tag has moved. The sensors 150 report the EPCs of the tags, whether or not they have moved, and/or other information, such as angles-of-arrival and quality metrics, to the appliance 140. The appliance 140 uses this information to estimate the locations of the tags 101. (The appliance 140 can also be configured to determine channel estimates and use them to locate tags 101.) The RFID tags 101 are attached to objects (not shown) in the environment 10. These objects may be items for sale, such as articles of clothing; fixtures or furnishings 120a-120c (collectively, fixtures 120), such as tables, shelves, walls, or doors; or people, such as employees, customers, or other visitors. The environment 10 can be bounded by walls 110 and 112, a ceiling, and a floor, any of which can reflect or scatter RF signals from the RFID tag readers 150 and/or RFID tags 101.

People, furnishings 120, and other objects can block, attenuate, and/or scatter RF signals transmitted by the RFID tag readers 150 and the passive RFID tags 101. These furnishings 120 can include shelves, racks, cabinets, etc. that may be used to hold the objects to which at least some of the RFID tags 101 are attached. (There may also be RFID tags 101 on at least some of these furnishings 120, for example, reference RFID tags 101 whose locations are known and can be used to locate RFID tags 101 at unknown locations.) For example, some furnishings 120 may comprise metal shelving that holds one or more items for sale (not shown in FIG. 1A) that are tagged with the RFID tags 101. The furnishings 120 can be arranged in rows in some settings, with aisles separating the rows to allow access to all objects tagged with RFID tags 101.

The tags 101 themselves can also interfere with RFID tag measurements. Tags 101 that are stacked on top of each other or placed close to each other (e.g., within 1, 2, 5, or 10 cm of each other) can reduce each other's ability to be activated by and/or respond to interrogation signals from nearby readers 150. Without being bound by any particular theory, this degradation in RFID tag performance can be caused by tag detuning, tag shadowing, and/or re-radiation cancellation. Tag detuning in an RFID tag is caused by power loss due to an impedance mismatch, caused by a coupling to a nearby RFID tag, between the RFID tag's antenna and integrated circuit (IC). Without being bound to any particular theory, tag shadowing and re-radiation cancellation may be caused by interference between backscattered RF waves from other RFID tags and incident interrogation signals from the reader. These effects operate on different length scales and can be difficult to model and predict given the large number of ways that RFID tags can be stacked or arranged and can interact with each other. These problems stem from how passive RFID tags operate. For more information on these problems and how to mitigate them, see, e.g., International Application No. PCT/US2023/061645, entitled “Stateful Inventory for Monitoring RFID Tags” and filed Jan. 31, 2023, which is incorporated herein by reference in its entirety for all purposes.

The RFID tag readers 150 are preferably installed in the RFID environment 10 such that every RFID tag 101 in the environment can communicate with at least one of the RFID tag readers 150. In a typical installation, the RFID tag readers 150 are mounted to or suspended from the ceiling. If the ceiling is a drop ceiling or secondary ceiling, the RFID tag readers 150 can be hung from the ceiling panels, mounted to the ceiling panels, or placed between the ceiling panels and the structural ceiling as disclosed in International Application No. PCT/US2022/081761, entitled “Antenna Arrays and Signal Processing for RFID Tag Readers” and filed on Dec. 16, 2022. In addition, or instead, one or more of the RFID tag readers 150 can be mounted to the walls 110 or 112 or fixed furnishings 120.

The cameras 130 capture images of at least portions of the environment 10 and of people and things within the environment 10. The cameras 130 are communicatively coupled to the appliance 140, which receives and processes images from the cameras 130 and tag reply data from the RFID tag readers 150. If desired, the appliance 140 can use the images from the cameras 130 and the data from the RFID tag readers 150 to trigger tag readings by the readers 150 and/or to locate the RFID tags 101 and associate them with people and/or objects in the environment. The appliance 140 can also determine a route from a person's location to a particular RFID tag 101/object, for example, if the person is looking for the object or the object should be moved from its current location. The appliance 140 can recognize the person from the image or from an RFID tag 101, smartphone, or other wireless device carried by the person and can trigger a sale of the object or other inventory change based on the person's movements with the object.

The RFID tag readers 150 may communicate with each other and/or with the appliance 140 via wireless or wired (e.g., Ethernet) connections. The appliance 140 may be a specialized computing device or a suitably programmed computer, laptop, or smartphone adapted to communicate with the RFID tag readers 150 and issue commands recognizable to the RFID tag readers 150. The appliance 140 can also receive signals from the RFID tag readers 150. For example, the appliance 140 can command the RFID tag readers 150 to inventory all RFID tags 101 (and attached items) in the environment 10 or to determine the location of one or more RFID tags 101 (and attached item(s)) in the environment 10. The appliance 140 can also command the RFID tag readers 150 to query the RFID tags 101 according to a schedule, e.g., as described in International Application No. PCT/US2022/026198, entitled “RFID Tag Readers Switchable between Interrogator and Listener Modes,” which is incorporated herein by reference in its entirety for all purposes. The RFID tag readers 150 can send raw or processed data representing the RFID tags' replies to the appliance 140, which uses this data to identify and/or locate the RFID tags 101 and/or attached objects as described below.

Each RFID tag reader 150 includes an antenna array, such as a four-element square antenna array, that transmits signals to the RFID tags 101 and receives replies from the RFID tags 101. The RFID tag readers 150 switch or hop the signals among different frequency channels (carrier frequencies), e.g., within bands of 865-868 MHZ (Europe) or 902-928 MHZ (North America). They can also use their antenna arrays to steer the transmitted signals and/or receptivity patterns to different angles of arrival (AOAs). The RFID tag readers 150 detect replies from the RFID tags 101 with their antenna arrays too.

These signals and replies can experience attenuation (fading), interference, scattering, and/or other effects as they propagate between the RFID tag readers 150 and the RFID tags 101. This distortion can vary with carrier frequency and tends not to vary with time, neglecting variations due to movement of people (and objects carried by people) about the environment 10. If the fading between a particular RFID reader 150 and a particular RFID tag 101 is too high, or if a furnishing 120, person, or object blocks the pathway between them, then that RFID tag 101 may not detect signals from that RFID tag reader 150 and/or that RFID tag reader 150 may not detect replies from that RFID tag 101.

FIG. 1A shows round-trip propagation paths followed by signals and replies between some of the readers 150 and tags 101 (transmitters and receivers). These paths are called communications channels 15 or communication links. Each communications channel 15 corresponds to a particular pair of physical endpoints (a particular reader location and a particular tag location) and can be characterized by channel state information or a channel estimate that describes how a signal propagates along the communications channel 15 at a particular carrier frequency. For example, communications channels 15a-a and 15b-a are between tag 101a and readers 150a and 150b, respectively. FIG. 1A shows some of the effects experienced by signals propagating via different communications channels, including multipath (communications channel 15a-b between sensor 150a and tag 101b), scattering (communications channel 15a-c between sensor 150a and tag 101c), and fading or attenuation (communications channel 15a-d between sensor 150a and tag 101d).

Each channel estimate represents the combined effects, at a particular carrier frequency, of multipath, scattering, fading, power decay with distance, etc., between the tag and the reader that define the endpoints of the corresponding communications channel 15 as well as the antenna responses of that tag and reader. (Noise, sensor calibration errors, and algorithmic imperfections (e.g., channel estimation errors) can also affect the decoding of the replies but tend not to degrade the communications channels 15 themselves.) Each channel estimate can also account for distortion, filtering, amplification, attenuation, and other effects caused by components in the communications channel, including filters, amplifiers, analog-to-digital converters (ADCs), antennas, and so on in the sensor. The channel estimates can also vary with transmission parameters of the interrogation signals and the sensors' antenna arrays, including originating sensor, carrier frequency, and beamforming sector, and so can be indexed or stored in the LUT according to these parameters. Other parameters that affect channel estimates include the environmental parameters, including the tag's proximity to other tags, which can be measured or estimated using computer vision techniques.

If the environment 10 includes different types of RFID tags 101, e.g., RFID tags with different shapes, sizes, antennas, and/or tolerances, then the communications channels and channel estimates can also vary depending on the type of RFID tag 101. An RFID tag reader 150 can identify the type of RFID tag 101 from the EPC or other information encoded in the tag's reply or by querying the tag. For example, the RFID tag reader 150 can query the RFID tag 101 for appropriate identifying information. The RFID tag reader 150 can use the RFID tag's reply to identify the (type of) RFID tag 101 and derive the channel estimate for the communications channel between the RFID tag reader 150 and the RFID tag 101. The RFID tag reader 150 can also parameterize the channel estimate by the sensor 150 that emits the interrogation signal, carrier frequency of the interrogation signal and reply, and the beamforming sector of the RFID tag reader 150.

Because the RFID tag readers 150 and RFID tags 101 occupy different positions, each communications channel is unique. The uniqueness of each communications channel comes from the relative angles at which the signal hits the different elements of the receiving antenna array. If a tag 101 moves, then the communications channels—and hence the respective channel estimates-between that tag 101 and the sensors 150 change. Unless the environment 10 changes, however, the channel estimate between a given pair of locations for a given set of parameters (e.g., sensor, beamforming sector, signal/reply carrier frequency, and tag orientation relative to the sensor) should not change. This means that the channel estimate for a communications channel between a fixed sensor 150 and a tag 101 at a given location, parameterized by RFID tag type, beamforming sector, and signal/reply carrier frequency, should remain valid for the tag's location and orientation even if the tag 101 is moved. Since the sensors 150 are fixed, the channel estimate for a particular sensor 150, operating at a particular carrier frequency and beamforming sector, can be mapped to the location and orientation of a particular tag 101, which can be determined from video or still imagery acquired by the cameras 130, from AOA or other measurements by the RFID tag readers 150, or other sources, including a priori knowledge.

Each sensor 150 (or the appliance 140) can store the tag locations indexed by channel estimate and parameter (e.g., carrier frequency, beamforming sector, and, optionally, tag type) in a lookup table (LUT) or other data store. Each sensor 150 (or the appliance 140) can use the stored information to estimate the locations of other RFID tags 101 from the stored channel estimates. When a sensor 150 receives a reply from a tag 101 whose location is unknown (e.g., a new tag 101 or a tag 101 that has been moved), the sensor 150 (or the appliance 140) derives the channel estimate for that tag 101 based on the reply and uses the channel estimate to look up the closest location in the LUT. If multiple sensors 150 locate the same tag 101, then the appliance 140 can corroborate, weight, and/or average these location estimates for greater accuracy.

When a sensor 150 detects a reply from a tag 101, the sensor 150 (or appliance 140) computes the channel estimate based on the tag's reply, which is a modulated and backscattered portion of the continuous-wave portion of the hop as transmitted by the sensor 150. The sensor 150 compares the channel estimate from the tag's reply against the most recent channel estimate for the same tag 101. If the current channel estimate is close enough (e.g., within a threshold distance in channel estimate space) to the most recent channel estimate, then the sensor 150 estimates the tag 101 to be in the same location as it was before. If the tag's current channel estimate is not close enough to the most recent channel estimate (e.g., farther than the threshold distance) or the sensor's LUT does not include any channel estimates for the tag 101, the sensor 150 uses the other channel estimates in the LUT with the same parameter set to find the closest matching channel estimate. The closest channel estimate is the channel estimate in the LUT with the shortest Euclidean distance in channel estimate space to the current channel estimate, optionally within a threshold distance or percentage. This closest matching channel estimate corresponds to an xyz position that can be retrieved to determine the tag's location. If the sensor 140 does not identify a suitable closest channel estimate, the sensor 150 or appliance 140 can estimate the tag's location using AOA, RSSI, or another location estimation technique.

Channel estimates generally exhibit correlation across carrier frequency, so the sensor 150 can also compare the current channel estimate to stored channel estimates at different carrier frequencies. When averaging or collecting statistics on the channel estimates, the sensor 150 can exploit the correlation to achieve greater averaging (curve fitting) or can interpolate between carrier frequencies to expand the channel estimates to carrier frequencies with fewer tag reads. Put differently, the sensor 150 can expand the parameter set beyond what was (thoroughly) measured.

Channel estimates incorporate the responses of the antennas at the endpoints of the communications channel (i.e., the sensor's antenna array and the tag's antenna). If either antenna has a response that varies with the polarization of the incident RF signal, rotating or re-orienting the tag 101 with respect to the sensor can change the channel estimate. More specifically, if the sensor's antenna array lacks circular polarization symmetry (i.e., if it responds differently to orthogonally polarized linear signals), then the sensor's channel estimate may vary with the orientation of a tag whose antenna backscatters linear or elliptically polarized radiation. This is because rotating that tag 101 with respect to the sensor's antenna array changes the projection of the polarization state of the backscattered radiation onto the antenna polarization, potentially changing the amplitude of the reply detected by the antenna array.

### RFID Tag Reader Architecture

FIG. 1B illustrates a reader 150 in greater detail, including components that can be enabled or disabled if the reader 150 is in interrogator mode or listener mode. The reader 150 includes an RF antenna array and front end 156, a processor 152, an RF calibration and tuning block 154, a hop generator 160, and a hop receiver 170. The RF antenna array and front end 156 may include one or more antenna elements (e.g., arranged in a multi-element antenna array), amplifiers, filters, and/or other analog RF components for transmitting RFID interrogation signals 151 and receiving tag replies 153 and, optionally, RFID interrogation signals from other readers. The processor 152 may be implemented in a microcontroller, application-specific integrated circuit (ASIC), field-programmable gate array (FPGA), or other suitable device and controls the operation of the reader 150, including, if desired, steering of the reader's antenna array. It stores information in and retrieves information from a memory (not shown), which may store lookup tables (LUTs) as described below, and communicates with the appliance 140 via a network connection (not shown), such as an Ethernet connection. If the reader 150 is configured to operate in interrogator and listener modes, the processor 152 switches the reader 150 between interrogator and listener modes, with the hop generator 160 being disabled or off in listener mode and enabled or on in interrogator mode and the hop receiver 170 being enabled or on in both modes. The RF calibration and tuning block 154 performs RF calibration and tuning functions.

The hop generator 160 generates the interrogation signals 151 that the reader 150 transmits to the RFID tags 101. The hop generator 160 can optionally also generate commands or communications signals intended for other readers 150, e.g., on a dedicated reader communications channel or with particular preambles or payloads. It includes a digital command generator 162, which generates the digital queries, commands, and/or other information conveyed by the interrogation signals 151, and RF electronics 164 for turning the digital signals from the command generator 162 into analog signals suitable for transmission by the antenna array in the front end 156. The RF electronics 164 may include a digital-to-analog converter (DAC) that converts the digital signal into a baseband analog signal, a mixer and local oscillator to mix the baseband analog signal up to an intermediate frequency for broadcast, and filters and/or pulse shapers to remove sidebands and/or spurs.

The hop receiver 170 includes a receiver front end 172 coupled to a command demodulator 174 and a tag reply demodulator 176. Generally, the receiver front end 172 digitizes, downconverts, and estimates the phase of the RF signals detected by the antenna(s). There are a variety of ways to configure the receiver front end 172; in this example, it receives analog in-phase and quadrature (I/Q) signals at higher frequency (e.g., 40 MHZ) and converts them into digital I/Q samples at baseband (e.g., 5 MHZ).

In interrogator mode, the front end 172 also cancels any self-interference caused by the interrogation signals 151, for example, due to leakage within the receiver. Fortunately, the receiver front end 172 can generally cancel crosstalk between different antenna elements and the circuits coupled to those antenna elements because the crosstalk is correlated with the interrogation signal 151. This crosstalk can be further reduced or suppressed by spacing the antenna elements farther apart from each other as explained in International Application No. PCT/US2022/081761, filed on Dec. 16, 2022, which is incorporated herein by reference in its entirety for all purposes.

When the reader 150 is in listener mode, it does not transmit an interrogation signal, nor does it perform self-interference cancellation. In listener mode, the reader 150 detects the channels on which the other readers 150 transmit interrogation signals 151 and estimates the frequencies of those other interrogation signals 151.

The command demodulator 174 is enabled when the reader 150 is in listener mode and demodulates commands from other readers to reproduce the interrogator's signals at the command bit rate (e.g., 40 kbps to 160 kbps). The command demodulator 174 uses the command payload to determine what the reader in interrogator mode is asking of the tag 130 (e.g., modulation, preamble type, expected reply type, etc.). For example, the reader 150 in interrogator mode may ask the tag 130 to send the first 64 bits of its EPC using Miller-2 modulation at 320 kHz backscatter link frequency (BLF) with the standard preamble. The readers 150 in listener mode use that information to decode the tag reply 153. The command demodulator 174 is disabled when the reader 120 is in interrogator mode.

The tag reply demodulator 176 is enabled in both interrogator and listener modes and demodulates the baseband tag reply I/Q samples to produce tag reply signals at the tag reply bit rate.

### Appliance Architecture

FIG. 1C shows the appliance 140 in greater detail. The controller appliance 140 can include one or more processors, non-volatile memories (for storing LUTs as described below), and other logic devices implemented as integrated circuits and powered by appropriate power supplies and other housekeeping electronics. These processors and logic devices may include discrete components that perform discrete functions and/or more general-purpose components that are programmed to perform a variety of functions, either by themselves or in concert with other components of the controller appliance 140. For instance, the controller appliance 140 may include a central processor unit (CPU) 142 running an operating system (e.g., Alpine Linux OS) that manages the controller appliance's hardware and software resources, including communications interfaces, shown as Ethernet connections Eth0 and Eth1, connected to the readers 150, the POS system, and/or other devices. The controller appliance's non-volatile memory can store the operating system and other firmware and software as well as tag state information.

FIG. 1C illustrates the appliance 140 as a block diagram, where each block represents a different function or sub-function performed by the appliance 140. To monitor and update tag states, the controller appliance 320 includes or implements an in-store message router 180, RFID interrogator controller (RFID-IC) 182, location state manager 184, tag state manager 186, and retail backend application programming interface (API) 188. The in-store message router 180 queues and routes messages exchanged between the readers 150 and RFID-IC 182 via the Ethernet connections Eth0 and Eth1. The RFID-IC 182 employs a split media access controller (MAC) design to handle messages exchanged with the readers 150, with a lower MAC layer implemented in the readers 150 and an upper MAC layer implemented in the RFID-IC 182. The lower MAC layer determines a timestamp and parameters, estimated from the RFID tag's backscattered response, useful for determining the tag's position. The upper MAC layer schedules hop transmissions and the general purpose of each hop. The lower MAC layer executes more time-critical functions, such as actually scheduling when to transmit commands and how to react to replies within a hop. A positioning layer comprising the RFID-IC and/or the reader(s) 150 calculates the RFID tag's position in a 3D coordinate system (e.g., Cartesian coordinates with an origin at a known location in the store or room) from data coming from the MAC and PHY layers. The messages from the reader 150 may also include data read from the RFID tag, including the RFID tag's EPC and other metadata.

The location state manager 184 and tag state manager 182 track the RFID tag's location and state, respectively. The location state manager 184 receives the RFID tag's estimated location from the RFID-IC 182 (e.g., in a Cartesian coordinate frame with the origin at one corner of the store) and determines where (e.g., the room and zone) in the RFID environment in which the RFID tag is located. The rooms and zones may be extracted from a 3D model of the store or space. In a retail RFID environment, the rooms and zones can include a receiving area, stockroom, sales floor, and changing room, with the sales floor further divided into an entrance/exit zone and a checkout zone. The location state manager 184 updates each RFID tag's location in an inventory database 190, which may be hosted locally or off site (e.g., in the cloud), based on changes in location detected by the reader(s) 150.

The tag state manager 186 manages the tag's state, including its location and availability. There are several possible availability states, including but not limited to: (1) available; (2) stale (optional); (3) ignored; (4) missing; and/or (5) sold. There may be other states as well. The tag state manager 186 transitions the RFID tags 101 among these states based on the tags' responses (or lack of responses) to queries from the readers 150, including information about the tags' locations, and on the tag states stored in the inventory database 190. For more on tag states and stateful inventory management, please see International Application No. PCT/US2023/061645, filed on Jan. 31, 2023, which is incorporated herein by reference in its entirety.

The tag state manager 186 updates the tag states stored in the inventory database 190 and forwards both the tag state and tag location estimate to the retail backend lite API 188, which implements the backend functions for inventory, restocking, and product lookup. The retail backend lite API 188 can implement these functions via a web app gateway 194, which implements a Hypertext Transfer Protocol (HTTP) proxy, redirecting Representational State Transfer (REST) requests to the appropriate backend server (not shown). The web app gateway 194 can also provide user authentication and authorization and serves the static files used by browsers to render web pages.

FIG. 1C also shows several optional components of the appliance 140, including a raw tag server 192, space server 193, Trivial File Transfer Protocol (TFTP) server 195, multicast Domain Name Service (mDNS) server 196, Network Time Protocol (NTP) server 197, Secure Shell (SSH) server 198, and Secure Sockets Layer (SSL) certificate store 199. The space server 193 handles firmware lifecycle management and configuration of the sensors 150 and Power-over-Ethernet (POE++) switches (not shown) that connect the appliance 140 to the sensors 150. The raw tag server 192 retrieves tag metadata for legacy APIs, such as those used by API clients for system debugging. When they boot, the sensors 150 download executable images from the TFTP Server 195. The mDNS server 196 enables the appliance 140 to advertise itself using the mDNS and DNS-SD protocols, e.g., for during debugging. The NTP server 197 connects and synchronizes with a remote (e.g., Internet-based) NTP server and provides NTP service to the sensors 150. The SSH server 198 is also used for debugging. And the SSL certificate store 199 hosts the server certificates used by the sensors 150 and the web-server certificate used by the REST clients to authenticate the appliance 140.

### Generating and Using Channel Estimates for Locating RFID Tags

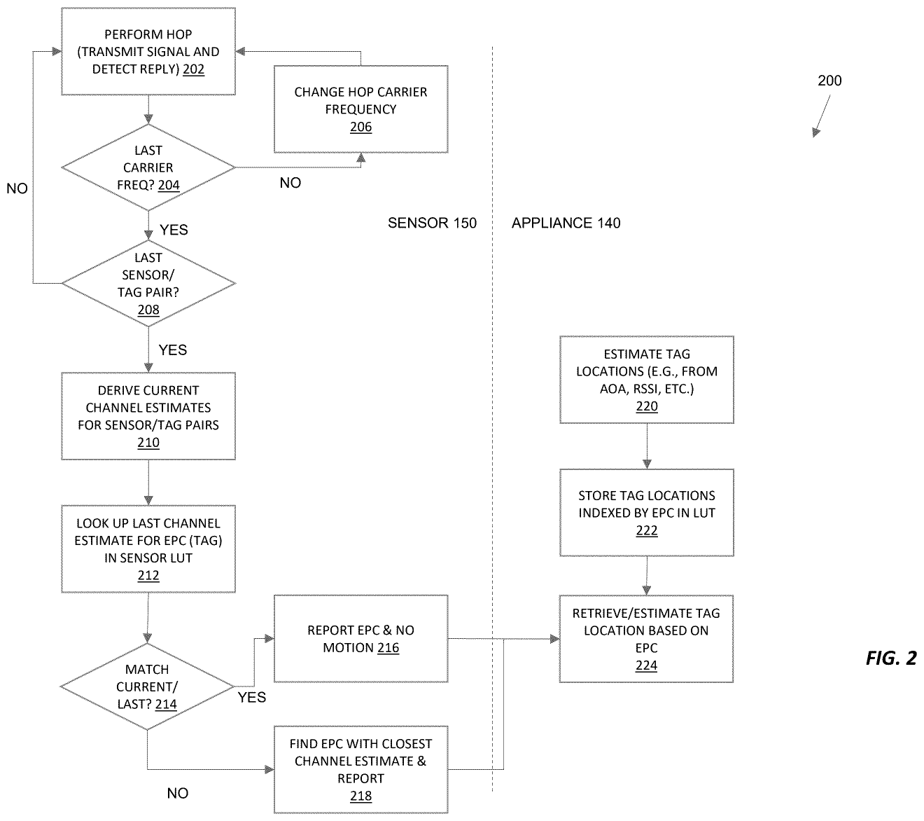

FIG. 2 illustrates a process 200 for locating RFID tags using channel estimates with an RFID tag location system like the one shown in FIG. 1A. The sensors perform or cycle through a series of hops (202) in which they interrogate the tags in a store, warehouse, or other environment. Each hop involves transmitting an interrogation signal from a sensor to a tag at a particular carrier frequency and detecting the tag's reply at the sensor that transmitted the interrogation signal and/or other sensors, e.g., as disclosed in International Application No. PCT/US2022/026198, entitled “RFID Tag Readers Switchable between Interrogator and Listener Modes,” which is incorporated herein by reference in its entirety. The sensor transmits both continuous-wave and modulated RF radiation, and the tag backscatters portions of the continuous-wave RF radiation, modulating a portion of the backscattered RF radiation with its EPC and/or other information in response to the commands transmitted by the sensor.

The sensors cycle through the different parameters over the series of hops, including different in-band carrier frequencies (204 and 206) and antenna array beamforming sectors (not shown), until the system has attempted to detect a reply for each sensor/tag pair in the environment at one or more combinations of parameters (208). The sensors may cycle through every possible combination of parameters or subset of parameters (e.g., a particular sensor or carrier frequency) when interrogating tags in a given environment, depending on the available time and the goal of the interrogation (e.g., inventorying tag or locating a particular tag or subset of tags). In practice, the system may not collect replies (or determine channel estimates) for each sensor/tag pair at every possible combination of parameters.

If the sensor has read a tag before, it can use the SELECT command to address that tag. Only that tag responds to the sensor's signal with its EPC. Once the tag has been selected, the sensor can sweep through entire set of transmission parameters (carrier frequencies, beam sectors, etc.) and generate a channel estimate for each combination of transmission parameters in the set. The sensor populates its LUT with these channel estimates, possibly indexed by the tag's EPC.

Each sensor (or the appliance coupled to the sensors) computes or derives the channel estimates at the different parameter combinations based on the continuous-wave portions of the detected replies (210). Each channel estimate can be characterized as a transfer function H(k) that acts on an input or transmitted signal X(k) to produce an output or received signal Y(k):

$$Y ( k ) = H ( k ) X ( k ) + noise .$$

For an RFID tag, the transmitted signal X(k) can be the continuous-wave (CW) portion of the interrogation signal transmitted by the sensor to the tag, and the received signal Y(k) can be the portion of the tag's reply modulated with the tag's EPC. The sensors (or the appliance) can perform these channel estimate calculations while the sensors are still performing hops or after the sensors have completed the hops.

For example, the sensor can transmit CW radiation to tag, powering up the tag. The sensor then transmits a command or query to the sensor, followed by additional CW radiation. The tag replies to the command or query by backscattering the CW radiation modulated with a random 16-bit number. The sensor echoes this random 16-bit number in an acknowledgement (ACK) to the tag, which causes the tag to reply with an ACK-Reply that encodes the tag's EPC and an appended cyclic redundancy check (CRC). The sensor can use the random 16-bit number and/or the ACK-Reply to form the channel estimate. The ACK-Reply is longer, enabling more averaging, and has a CRC to validate that the sensor has decoded the bits correctly. The sensor can adapt the channel estimate as it receives EPC bits (or symbols) to reduce or minimize the error associated with the channel estimate.

Each sensor looks up a historical channel estimate, such as the last channel estimate or a moving average channel estimate, stored in its LUT for the same EPC (212) and compares the current channel estimate for each tag (EPC) to the historical channel estimate. If the current and historical channel estimates match (214) to within an acceptable number of standard deviations (e.g., four standard deviations, three standard deviations, two standard deviations, one standard deviation, or a fraction of a standard deviation), then the sensor reports to the appliance that the tag has not moved (216). If the current and historical channel estimates do not match to within an acceptable number of standard deviations, or if there are no historical channel estimates for the EPC in the sensor's LUT, then the sensor identifies the historical channel estimate in the LUT that is closest to the current channel estimate and the corresponding EPC and reports at least the corresponding EPC to the appliance (218).

For example, the sensor may measure the Euclidean distance between the current channel estimate and the channel estimates stored in the LUT in channel estimate space, where a Euclidean distance of 0 means the two channel estimates are identical. The appliance can apply a threshold (e.g., based on the standard deviation among channel estimates for that communications channel) to decide if a stored channel estimate is close enough to the current channel estimate to report a match. If desired, the sensor can use different thresholds in different areas of channel estimate space, e.g., lower thresholds in densely populated areas (regions rich in signatures) and higher thresholds in sparsely populated areas (regions starved of signatures). Put differently, the sensor can accept a poorer match in areas with fewer channel estimates. The threshold(s) can be correlated with desired spatial (e.g., xyz) performance, either empirically or theoretically, and used to assess the quality or fidelity of the location estimates.

Again, for each tag reply that it receives, the sensor determines whether or not the corresponding tag has moved and the EPC corresponding to the historical channel estimate in the sensor's LUT that (best) matches the tag's current channel estimate. The sensor reports the motion indication and the EPC to the appliance, which estimates tag locations based on AOA, RSSI, or other information and stores the tag locations indexed by EPC in its own LUT. (The appliance and sensors can populate their respective LUTs asynchronously.) The appliance uses the motion and EPC information from the sensor to retrieve the corresponding tag location from its LUT or compute the tag location on-the-fly from AOA or other information acquired by the sensors (224).

The appliance can estimate the locations of the tags in the RFID environment (220) based on AOA, RSSI, or other measurements by the sensors, images from the cameras, or other information, including user input. For example, the appliance can locate each tag for which it has calculated a channel estimate using any suitable technique, including correlations based on images acquired by the cameras, triangulation or trilateration based on AOA or RSSI measurements by the sensors, or user measurements and data entry. The appliance can locate the tags before, while, or after the sensors perform the hops and derive the channel estimates. The appliance and sensor can also locate tags and derive channel estimates in different orders for different tags and in a repetitive or interleaved fashion as tags enter and leave the environment, the extent of which may be set by the sensors' range. The appliance stores the tag locations, indexed by EPC, in a LUT or other local memory (222) for matching (224) against EPCs that the appliance receives from the sensor (216/218).

Alternatively, the appliance can store tag locations indexed by channel estimate in its LUT and use the channel estimates derived by the sensors to look up the tag locations corresponding to the current channel estimates. In this case, the appliance can use the transmission parameters of the interrogation signals, including the SIDs of the sensors that emitted the interrogation signals, carrier frequencies, and beamforming sectors, to narrow the search space within the LUT. If the replies used to generate the channel and location estimates are for the same tag (i.e., they encode the same EPC) and that tag has not moved and the communications channel has not changed, then the channel and location estimates should match.

Theoretically, channel estimates for channels between different beamforming sectors in the same sensor and the same tag should be similar for nearby carrier frequencies; likewise, nearby tags should have similar channel estimates for a given set of parameters, provided that multipath effects do not dominate the channel estimates. If multipath effects dominate the communications channel (i.e., the LOS signal is much weaker than the reflected or scattered signals), then the correlation between channel estimates of tags even in close proximity may be poor. If the channel estimates for a given tag at different carrier frequencies do not behave in a manner consistent with a channel with strong (er) LOS signal, they can be excluded from the LUT or afforded a lower weight.

The process 200 shown in FIG. 2 can be carried out as follows. Consider an RFID tag reader that detects a reply from an RFID tag affixed to a first item sitting on a table at an unknown position at time t=0. At time 1=1, a person reaches for the first item and a camera or other sensor detects the spatial (e.g., xyz) coordinates of the person's wrist as the person picks up the item and walks away. The camera may capture imagery of the first item in the person's hand as the person walks away and/or the RFID tag reader may sense that the first item is moving. By time t=2, an appliance coupled to the camera and the sensor has attributed the first item to the person based on the imagery and/or correlation of the person's movement with the first item's trajectory based on data from the RFID tag reader. The appliance uses this correlation to place the first item's position at 1=1 at or near the spatial coordinates of the person's wrist at time t=1. The appliance also maps the EPC for the channel estimate measured at 1=0 to the spatial coordinates and stores the EPC and spatial coordinates in a LUT in memory. At time 1=3, the RFID tag reader senses a reply from a second item at roughly the same spatial coordinates. The sensor derives a channel estimate for the second item from its reply and matches it (closely enough) to the channel estimate derived for the first item. Based on this match, the sensor and appliance determine that the second item is at or near the spatial coordinates indexed in the LUT under the EPC derived for the first item.

The sensor can also follow the opposite order for estimating a tag's location from a channel estimate—that is, the sensor can measure a channel estimate for a tag at an unknown location, then the appliance can determine the corresponding location based on subsequently measured channel estimates of tags at known locations. For instance, a sensor can detect a reply from a first tag at an unknown first location. The first tag can be left at the first location or moved from that first location. Later, the same sensor detects replies from one or more tags at known locations, possibly including the first location or one or more locations close to the first location. The sensor derives channel estimates for the replies from the tags whose locations are known, and the appliance uses the channel estimates and known locations to estimate the unknown location.

Measuring channel estimates before locating the corresponding tags is especially useful when few if any tag locations are known. Consider a situation in which the tag location system is locating tags based on angle-of-arrival (AOA) measurements. AOA positioning (particularly if done overnight when tags are assumed to be stationary) benefits significantly from averaging over time, smoothing/characterizing over carrier frequency, and corroborating across measurements of the same tag by different sensors. It can take a relatively long time to acquire enough AOA measurements to ascertain a tag's location under these circumstances, so it makes sense to collect channel estimates for the tags before their locations are known and to populate the appliance's LUT with the tags' locations once they have been determined from the AOA measurements.

Similarly, it may be advantageous to collect channel estimates when a tag is not moving and when the communications channel to the tag is not subject to disturbances. If a person moves a tag or is moving near a tag, for example, this movement can change the communications channels between the tag and nearby sensors. (This movement can be detected by measuring the changes in the communications channels as described below or with a camera or other device independent of the sensors.) The sensor may capture a channel estimate for the communications channel to the tag after the tag has stopped moving and the person has left the area to reduce or avoid fluctuations in the channel estimate caused by movement of the tag or the person.

### Lookup Tables (LUTs) for Storing and Retrieving Channel Estimates

Storing the channel estimates in a LUT or database table enables the sensor to look up tag locations by channel estimate using a fast, simple array indexing operation or database query instead of a computationally more expensive, slower computation or input/output operation (e.g., computing the location based on AOAs or RSSIs). The LUT can store the means (averages) of the normalized channel estimates or more sophisticated representations of the channel estimates, including noise properties for a given parameter set. For instance, if the channel estimate follows a modal distribution instead of, or in addition to, a Gaussian distribution, the LUT could store a separate channel estimate or signature for each modal group so long as the RFID tag location system can resolve the channel estimate to a single EPC (RFID tag) per position. This example LUT shows EPCs and spatial (xyz) positions indexed by channel estimate and transmission parameter set (here, carrier frequency and beamforming sector):

TABLE 1
Example Lookup Table (LUT)

| | | Tag | xyz |
|---|---|---|---|
| Channel Estimate | Parameter Set | EPC | Position |
| Channel Estimate | Frequency_1_Sector_1 | 101 | 1, 1, 1 |
| Value 1 | | | |
| Channel Estimate | Frequency_1_Sector_1 | 102 | 1, 2, 1 |
| Value 2 | | | |
| Channel Estimate | Frequency_1_Sector_2 | 103 | 2, 3, 2 |
| Value 3 | | | |
| Channel Estimate | Frequency_1_Sector_2 | 104 | 2, 5, 1 |
| Value 4 | | | |

Other arrangements of LUTs are also possible, including a LUT at each sensor that stores channel estimates, EPCs, and transmission parameters and a LUT at the appliance that stores EPCs and estimated locations as described above with respect to FIG. 2.

Once the LUT(s) have been populated, they can be used to locate tags at unknown locations quickly and accurately. To do this, the sensor interrogates a tag at an unknown location. This tag could be a new tag or an existing tag whose location is unknown, for example, because it has been moved. The sensor (or appliance) derives the channel estimate for the communications channel between the sensor and the tag at the unknown location based on the interrogation signal parameters and tag's reply. Again, the tag generates the reply by modulating and backscattering the continuous-wave portion of the hop as transmitted by the sensor. If the tag EPC is already stored in the LUT, then the sensor can look up the tag's previous channel estimate by the tag EPC and compare the tag's current channel estimate to the previous channel estimate. If the current and previous channel estimates are the same (or within a Euclidean distance threshold of each other), then the sensor returns the location associated with the previous channel estimate because the sensor has determined that the tag has not moved. If not, or if the tag EPC is not stored in the LUT, then the sensor looks up the EPC corresponding to the closest stored channel estimate for the parameter set (carrier frequency, beamforming sector, etc.) used to interrogate the tag. That is, if the tag's current channel estimate does not match its most recent channel estimate, the sensor determines that the tag has moved and looks in the LUT within the parameter set (e.g., sector and carrier frequency) associated with the channel estimate for the EPC with the channel estimate that is most similar to current channel estimate.

### Signature Creation/Formation and Signature Exploitation/Consumption Modes

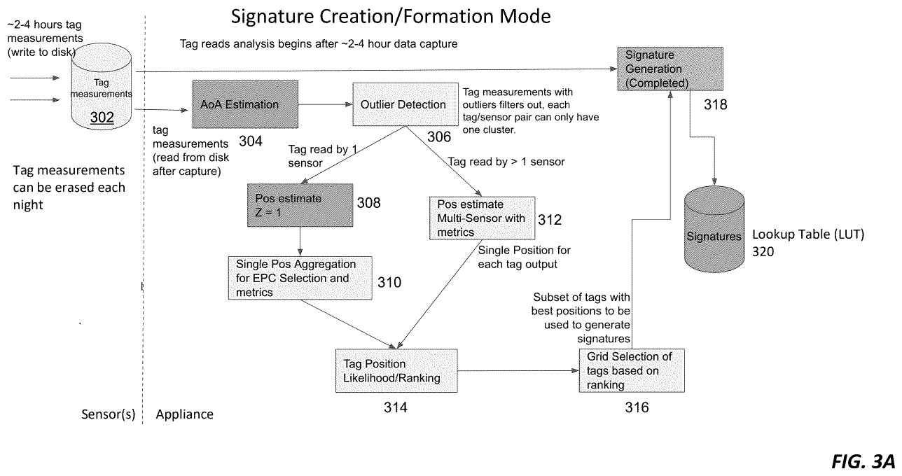

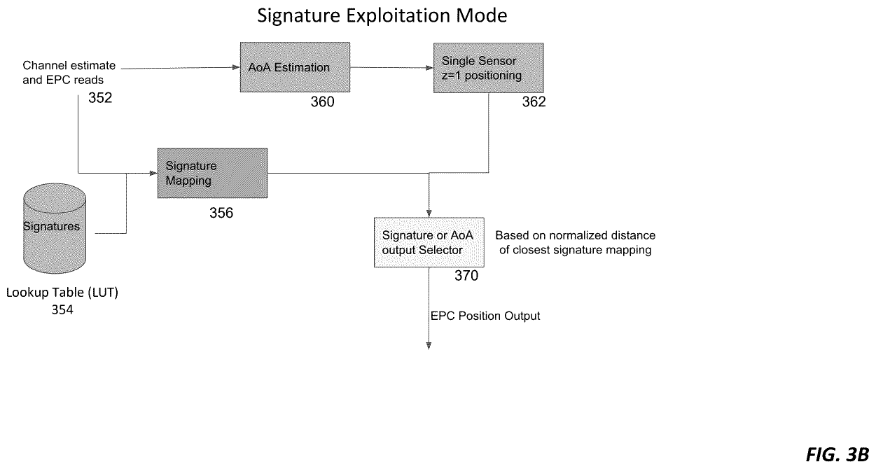

FIGS. 3A and 3B illustrate signature creation/formation and signature exploitation/consumption modes, respectively, for an RFID tag location system that uses channel estimates to locate RFID tags in a retail store or other environment. Typically, the system operates in signature creation/formation mode when the environment is relatively quiet and no tags, people, or objects are moving (e.g., at night) and in signature exploitation mode when the environment is busier and tags, people, or objects are more likely to be moving (e.g., during the day). In signature creation/formation mode, generally the goal is to generate the most accurate spatial location for each tag; in signature exploitation/consumption mode, generally, the goal is to estimate the tag's location as fast as possible.

In signature creation/formation mode, the sensors interrogate the RFID tags, and the sensor and appliance derive channel estimates for each sensor/tag pair, locate tags, map the channel estimates to EPCs and the EPCs to tag locations, and update the LUTs that store the channel estimates, EPCs, and tag locations. The system operates in signature creation/formation mode periodically (e.g., every night) or as desired (e.g., when the environment is closed to people or when no motion is detected) in order to update the RFID tag inventory, improve location accuracy, and account for changes in the environment caused by movement of RFID tags and other objects. In signature exploitation mode, the sensors interrogate tags at unknown locations and use the stored channel estimates, EPCs, and tag locations to make fast, accurate location estimates for tags at unknown locations.

In signature creation/formation mode, shown in FIG. 3A, the sensors make and store measurements of replies from the RFID tags in the environment (302), e.g., for 2-4 hours at a time. During this measurement period, every sensor tries to read every RFID tag within range as many times as possible at as many different (in-band) carrier frequencies as possible. The number of read attempts and number of measurements depend on the environment, number of sensors, number of tags, read rate, modulation scheme, carrier frequency, etc. The sensors might not be able to read some tags, e.g., because these tags are out of range or are covered or shielded by other objects. The sensors may read other tags on every attempt at every carrier frequency. The sensors may read other tags on some frequencies but not on other carrier frequencies. Likewise, each sensor may read some tags but not others.

The sensors and/or appliance store the channel estimates, which might be erased periodically (e.g., every night or every week). For each measurement, the appliance or corresponding sensor estimates the AOA from the tag to the sensor (304). The appliance discards AOA estimates that are statistical outliers, uncorroborated, too noisy, or physically unlikely or unrealistic (e.g., because they are at elevations too close to the ceiling or azimuths outside of the environment) (306). For tags read by only one sensor, the appliance generates position estimates from the AOA estimates assuming the tags are at a fixed height (e.g., z=1) or close in height to tags whose elevations are known or can be determined with multiple sensors, RSSI, or changes in phase with carrier frequency (308) and aggregates the resulting position estimates for EPC selection and other analysis (310). If a tag is read by more than one sensor, the appliance may generate a position estimate in three dimensions for each tag by triangulating the AOA estimates from multiple sensors (308).

The sensor also generates channel estimates, or signatures, possibly for each tag or possibly for only a subset of tags, such as those tags whose locations are known, depending on the available processing time, processing power, and/or user preference (318). The sensor generates each signature by filtering or parameterizing the corresponding channel estimate by the carrier frequency of the interrogation signal and/or other parameters used to generate the response. Each signature represents the communications channel between a particular sensor and a particular tag, or, more precisely, the location of that tag when it replied to the sensor. Each sensor stores each signature and the corresponding EPC in local memory.

The appliance stores the tag locations, indexed by EPC, in a local LUT or database (320). To map the EPCs to the tag locations, the appliance can aggregate the tag location estimates and assign a confidence level to each location estimate (314). Each confidence level indicates the likelihood or probability that the corresponding location estimate is correct and can be based on the observed SNR or RSSI; number of measurements, EPCs, or outliers; the relationship of the tag locations to fixtures in the environment; the noise seen on each measurement; and/or the distance between the channel estimates (in the complex channel estimate space) versus the distance between the corresponding positions (in real space). The appliance selects the location estimates with the highest confidence levels or those with confidence levels above a certain threshold and assigns the matching EPCs to the selected locations (316). In some cases, the appliance selects location estimates that form or fit onto or near points on a grid extending over the area being monitored by the sensors. The appliance stores these EPCs and locations in a memory, where the EPCs act as keys in a LUT or database table of possible RFID tag locations.

FIG. 3B illustrates signature exploitation mode. In signature exploitation mode, the RFID tag location system reads tags (EPCs) and estimates their locations constantly and returns their locations, e.g., in response to a sales associate's or customer's search for a particular item in the environment. When the sensor determines a new channel estimate, it filters the channel estimate by the sensor parameters and interrogation signal carrier frequency and uses the result to query its LUT by signature (354). The query returns the EPC corresponding to the closest channel estimate, which the sensor transmits to the appliance for looking up the corresponding location in the appliance's LUT (356). If different sensors return different EPCs, the appliance can select the closest corresponding location, e.g., using a voting process to find the most common EPC returned by the sensors, or average or interpolate the corresponding locations, possibly after weighting the locations based on the historical accuracy of the sensors. If there is no channel estimate in the sensor's LUT that matches closely enough (e.g., within a threshold Euclidean distance), then the appliance can estimate the tag's location based on AOA, RSSI, or another suitable observable quantity.

If desired, the appliance or sensor can estimate the AOA for each reply (360) and use the AOA to estimate the tag's location at a fixed height (e.g., z=1 meter) (362). The appliance or sensor can select either the tag location from the LUT or the tag location based on the estimated AOA as the most probable actual tag location (370), e.g., based on the normalized distance between the measured channel estimate and the closest signature in the LUT. The appliance can also average or combine the tag locations from the LUT and AOA estimation to produce a tag location that it provides for the tag (the EPC position output). If the appliance can compute only the channel estimate or the AOA for a given reply, then it can use that data to estimate the tag's location instead of using both the channel estimate and the estimated AOA. If the appliance has multiple channel estimates and/or AOA estimates for the same tag, it can use all of the estimates to identify possible tag locations and corroborate or combine the possible tag locations or keep a preferred set of estimates and the corresponding tag locations. And if the sensor and/or appliance determine that the channel estimate for a given tag is substantially the same as before, the sensor and/or appliance can skip the look-up process and simply report the tag's previously determined location.

### Locating RFID Tags Using Channel Estimates and AOA Estimates

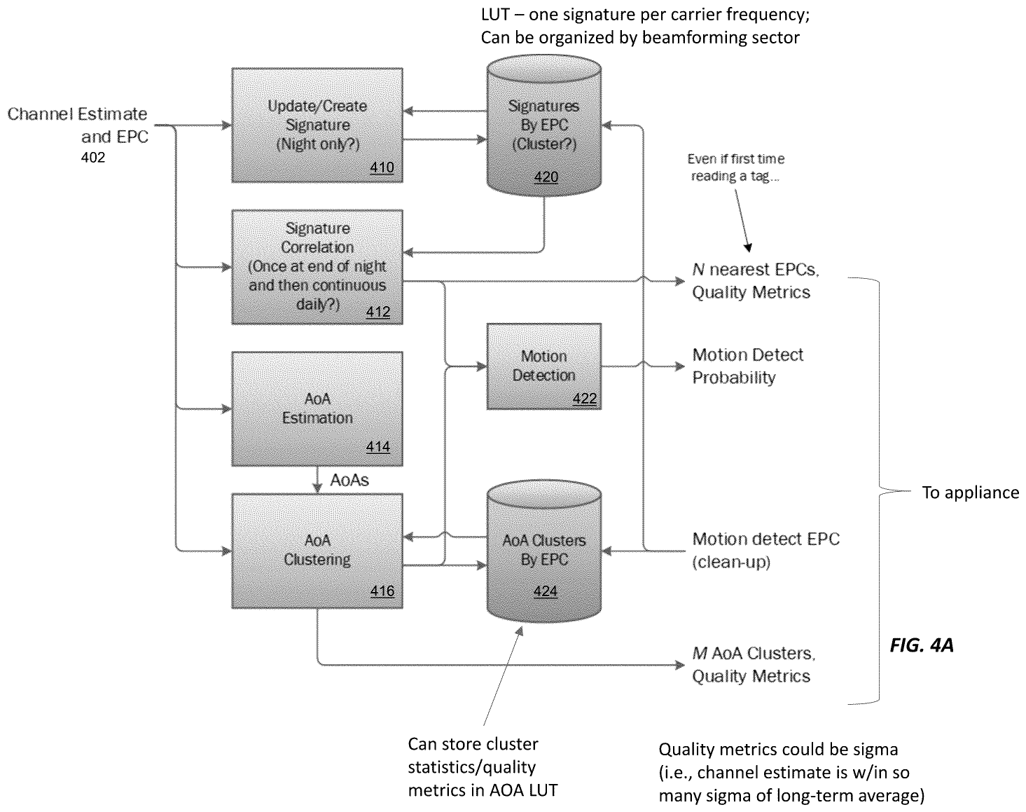

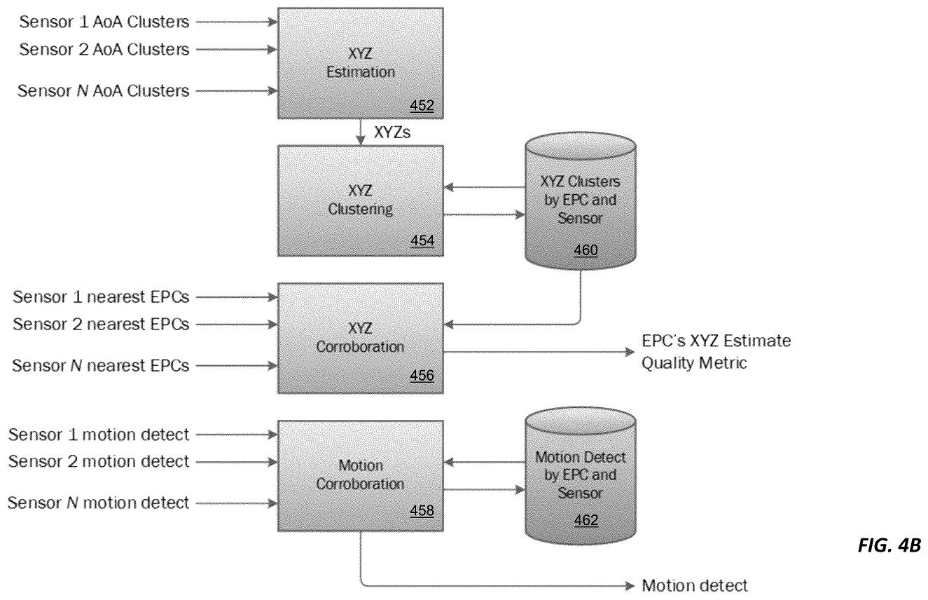

FIGS. 4A and 4B illustrate more detailed views of how to estimate the location of an RFID tag using both channel estimates/signatures and AOA estimates. FIG. 4A illustrates processing and aggregation of channel and AOA estimates by a single sensor. FIG. 4B shows how an appliance can process and corroborate EPCs, AOAs, quality metrics, and motion estimates from multiple sensors. The appliance and sensors can carry out these measurements and processing in signature exploitation mode. The sensor measurements can be processed as shown in FIG. 4A on/by the sensor that made the measurement or by the appliance or another processor coupled to the sensor. The appliance carries out the aggregation and processing shown in FIG. 4B.

As shown in FIG. 4A, a single sensor measurement for a given RFID tag includes both the EPC for that RFID tag and an estimate of the communications channel from the sensor to that RFID tag (402). In signature creation/formation mode, the sensor uses the channel estimate to create or update a signature for that tag/sensor pair (410), which it stores by EPC, antenna configuration/beamforming sector, interrogation signal/reply carrier frequency, and, optionally, type of RFID tag (420). The sensor can normalize the channel estimates before storing them to account for gain and phase fluctuations such that the gain and phase rotation reduces or minimizes root mean square (RMS) error when matching channel estimates for successive reads of the same tag (assuming that the tag has not moved). The sensor correlates the incoming/current channel estimate for each EPC with the historical channel estimates for the same EPC stored in the (sensor's) LUT (412); if the current and historical channel estimates do not match to within a given threshold or percentage, then the sensor reports that the tag has likely moved and may provide the EPC of the tag whose historical channel estimate most closely matches the EPC's current channel estimate to the appliance (422).

If the tags don't move, then the system effectively creates, stores, and updates a signature for each location in the environment that is (or has been) occupied by an RFID tag. The signatures (channel estimates) represent the communications channels between the sensors and the possible locations of the RFID tags and hence are clustered by sensor ID (SID) as well as by carrier frequency, beamforming sector, and other parameters (420). At the end of signature creation/formation mode and during signature exploitation/consumption mode, the appliance correlates the channel estimate with the previously created and stored channel estimates (412).

The sensor also estimates the AOAs for the tag replies (414) and clusters the AOAs for each tag (EPC) (416). The sensor can estimate AOAs for every reply or for only a subset of replies, e.g., replies whose channel estimates do not match any of the channel estimates stored in the sensor's LUT. The sensor transmits these AOAs to the appliance for determining the tag positions corresponding to the channel estimates as explained above. For example, the sensor may calculate a statistical distribution of the AOA estimates and group the AOA estimates based on that statistical distribution (e.g., by clustering AOA estimates that are within a certain number of standard deviations of each other). The sensor stores the clusters of AOA estimates by EPC in a memory or database and can provide them to the appliance for estimating the actual position of each tag. (424)

In some cases, one sensor may interrogate a given tag, and multiple sensors may detect the reply to that interrogation signal as described in International Application No. PCT/US2022/026198, which was filed on Apr. 25, 2022, and is incorporated herein by reference in its entirety for all purposes. If the tag is stationary, then the communications channels between the tag and those sensors should not change from interrogation to interrogation, and the channel estimate for each sensor/tag pair should remain constant. If the tag moves, however, then all of the communications channels—and hence all of the channel estimates-should change. Thus, simultaneous changes in multiple channel estimates may cause the appliance to determine with high (er) confidence that the tag has moved since it was last read. Conversely, if one channel estimate changes and others do not change, then the appliance may determine that the corresponding communications channel has changed but the tag has not moved.

The sensor also estimates or determines quality metrics related to the tag replies, signatures, and/or AOA estimates. These quality metrics may include, but are not limited to variance, signal-to-noise ratio (SNR), read rate (how often the tag is read), RSSI, estimated elevation, AOA variance, channel estimate variance, whether the measurements or estimates are modal, whether the measurements or estimates are clustered, the levels of agreement for an estimate from different sensors, or boresight sector, which limits the volume over which a sensor reads tags). The sensor can transmit these quality metrics to the appliance along with the EPCs, motion detection information, and AOAs.

FIG. 4B illustrates a tag location process performed by the appliance/interrogator controller every time a sensor receives a tag reply and provides the corresponding EPC, motion detection information, quality metrics, and optional AOA to the appliance. The appliance uses the clusters of AOA estimates from multiple sensors to estimate the location (xyz estimation) of each tag (452). If the motion information from the sensor indicates that the tag has not moved, then the appliance can simply retrieve and return the tag's last known location. If the motion information indicates that the tag has moved or is new, then the appliance computes and returns the tag's location from the AOAs associated with that tag's EPC as measured by multiple sensors. (If the sensors are far away from a tag, or if not enough sensors receive replies from a tag, then the appliance may assign a predetermined height to the tag and estimate the tag's spatial location based on only one or two AOAs.)

The appliance clusters these xyz location estimates for the different EPCs and SIDs (454), e.g., based on their physical proximities, their proximities in channel estimate space, or the statistics of their distribution, and stores them in a database or memory for later use (460). For example, if the desired tag location accuracy is 50 cm, then the appliance can put location estimates that are separated by 2 m or more in separate clusters. The appliance stores the clustered location estimates indexed by tag (EPC) and/or by sensor (SID).

The appliance also corroborates the spatial (e.g., xyz) location estimates from each sensor with spatial location estimates from other nearby sensors (e.g., the nearest SIDs) (456). In general, the appliance may assign a higher confidence level to a spatial location estimate that matches or is close to spatial location estimates from other sensors. The appliance can also corroborate a spatial location estimate by a given sensor for a given tag with other, older spatial location estimates by the same sensor for the same tag. The appliance can determine whether spatial location estimates match each other by calculating their variance or another measurement of the dispersion of the spatial location estimates and prefer the spatial location estimates with the lowest variances. The appliance returns a spatial location (xyz) estimate for each tag (EPC) and may also return the SIDs of the sensors that provide the best, or most likely to be accurate, estimates of the tag's location.

In addition to corroborating spatial location estimates, the appliance can corroborate motion detection by the sensors (458). Per FIG. 3A, each sensor provides an indication to the appliance about the probability that a given tag has moved. The appliance stores these motion detection indications by EPC and sensor (e.g., by SID) in a memory or other data store (462) and corroborates them by EPC and/or by sensor. If motion detection indications from multiple sensors indicate that a tag is likely to have moved, then the appliance can report that the tag has moved or is likely to have moved. If a tag is read by many sensors, but only one sensor shows that the tag has moved, then the appliance can report that the tag has not moved or is unlikely to have moved. If a single sensor reports that multiple tags have moved, but no other sensors detect movement of (channel estimate changes for) those tags, then the appliance can determine that the tags have not moved that the communications channels associated with that sensor have changed, possibly due to movement of people or objects between that sensor and the tags. Similarly, if a group of sensors on one side of a tag detect likely movement of that tag, but sensors on the opposite side of that tag have not detected any movement, then the appliance can determine that an object or person may have passed between the tag and the sensors that detected the movement (channel estimate changes).

The appliance can corroborate motion detection indications (channel estimate changes) across time as well as across space/sensors. For example, if a single sensor reports a high probability of motion at a first time, then reports no motion in subsequent readings, the appliance may determine that the tag has not moved, especially if the tag's channel estimate returns to its original state. If different sensors report movement (channel estimate changes) for a given tag over time, then the appliance may determine that the tag is moving and estimate its trajectory based on its estimated locations and/or the spatial locations of the sensors.

The appliance can also use the EPC to select the best or most likely location of tag from among tag location estimates provided by multiple sensors. In other words, the appliance can use all available information about the tag's location regardless of which sensor(s) read the tag. Consider, for example, a sensor that returns a poor or highly uncertain location estimate for a given tag. The uncertainty may be caused by a noisy channel estimate, high attenuation, or severe multipath in the communications channel. Even though the location estimate and underlying channel estimate are poor or highly uncertain, the appliance determines that they are consistent with the most recent location and channel estimates and conclude that the tag is in the same location, regardless of which sensor estimated that location.

### Detecting (Tag) Movement Using Channel Estimates

A sensor or appliance can also sense movement, of a tag or of another object, based on changes in channel estimates. For example, a sensor or appliance can determine whether or not a tag is moving based on changes in its signature (and/or AOA) over time. If a tag's signature changes drastically, then changes back, the sensor or appliance may determine that the changed signature is from a spurious measurement or transient movement (e.g., the tag was picked up and returned to its original location) and discard the measurement. On the other hand, if a tag's signature (channel estimate) or estimated AOA indicates that the tag has moved by several meters or more between reads, then the sensor or appliance may determine that the tag is moving and update other systems, such as an inventory database or payment system, about the movement for triggering restocking, sale, or loss prevention of the item attached to the tag. Similarly, the appliance may determine that a tag is moving if different sensors detect changes in the tag's signature, e.g., caused by changes in the tag's ranges to those sensors.

In addition, the appliance can corroborate motion detected by a sensor with measurements from other sensors and/or other data sources. It can be difficult to detect true motion (as opposed to spurious motion) with a single sensor, especially if the tag is moving towards or away from the sensor so the AOAs of the tag's replies do not change. Several sensors can usually detect movement of a tag reliably, especially if the movement results in a relatively large change in the tag's position. If tag locations over time from several sensors show that the tag is moving, the appliance can report the tag's motion and trajectory. The appliance or sensor can also wait a period of time (e.g., 15 seconds, 30 seconds, 1 minute, 5 minutes, etc.) to see if the tag's channel estimate snaps back to its more historical value, possibly indicating that the communications channel was perturbed but the tag stayed stationary. Changes in a tag's signature can also be correlated with motion detected using a camera to confirm that the tag is actually moving.

The sensor, which collects and averages channel estimates on a per-EPC basis, can sense when a tag's channel estimate is out-of-family (e.g., is far enough from its most recent channel estimate in channel estimate space to suggest that the tag has moved). If the tag's channel estimate is out-of-family, the sensor can form a temporary second channel estimate and begin the averaging/signature formation process for the corresponding new location. If the communications channel and channel estimate continue to change, e.g., because the tag is moving and/or there is movement in the tag's surroundings, the sensor can discard the new channel and location estimates. Once the motion stops, the communications channel and channel estimate should stabilize (or the tag should disappear if it has moved to an out-of-range area), in which case the sensor discards or purges the temporary and/or legacy channel and location estimates for the tag.

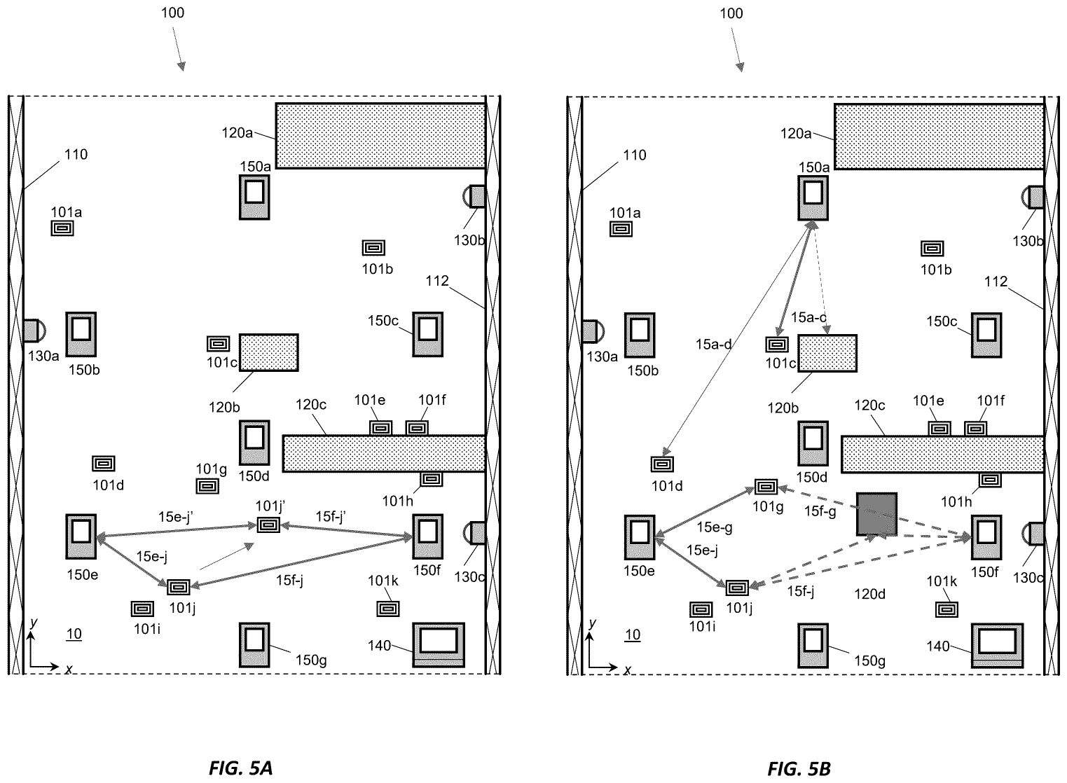

FIG. 5A illustrates how sensors 150e and 150f detect movement of tag 101j in the environment 100 of FIG. 1A based on changes in the channel estimates for communications channels 15e-j and 15e-f between the sensors 150e and 150f and the tag 101j. In this case, the tag moves between two positions (indicated by a single-headed arrow and reference numbers 101j and 101j′ for the tag's starting and ending positions, respectively). Communications channels relative to the sensors 150 are location-specific, so the communications channels change between the sensors 150e and 150f and the tag 101j change from 15e-j and 15f-j to 15e-j′ and 15f-j′. The tag 101j has moved farther from sensor 150e, resulting in more attenuation (fading) and a longer delay in the communications channel 15c-j′ between the tag 101j and sensor 150c. This change in range between the tag 101j and the sensor 150e also changes the relative path differences between the tag 101 and the sensor's antenna elements, imparting corresponding phase changes to the signals received by the antenna elements. The phase changes (and fading) produce a corresponding change in the channel estimate. (Generally, detectable changes in communications channels due to tag motion manifest as relative phase changes between antenna elements. If the LUT stores a tag's typical RSSI, which is a function of beam-steering sector since tag reflects the power it receives, then changes in amplitude/attenuation can also cause the sensor to revise its channel estimate.)

At the same time, the tag 101j has moved closer to sensor 150f, resulting in phase changes and less attenuation in the communications channel 15f-j′ between the tag 101j and sensor 150c and a corresponding change in the channel estimate. Sensors 150e and 150f detect corresponding changes in the channel estimates for the 101j. Other sensors within range of the tag 101j, including sensors 150b, 150d, and 150g, may also detect changes in the channel estimates for tag 101j. Some sensors 150 may come into or go out of range as the tag 101j moves.

The sensor 150e and 150f each use the EPC or other unique identifier encoded in the tag's replies to look up their previous channel estimates for the tag 101j. If their current channel estimates do not match the previous channel estimates (e.g., to within a predetermined threshold or percentage), then the sensors 150e and 150f determine that their channel estimates for the tag 101j have changed. The sensors 150e and 150f use these updated channel estimates to derive new location estimates for the tag 101j by finding a match to another tag's channel estimate and assuming the tag 101j is at the other tag's position or by using AOA, RSSI, or another suitable method to estimate the tag's new location. Ideally, the new location estimates from sensors 150e and 150f are coincident with each other to within the error radius associated with the location estimation process. The new location estimates can be averaged to produce a more accurate location estimate for reporting to a user. If the new location estimates are not coincident with each other (at least not to within the error radius), the appliance 140 may discard potentially erroneous location estimates and/or estimate the location of the tag 101j based on other data. The sensors 150 may keep the old (current) channel estimate for a given tag 101 while beginning to accumulate and average new channel estimates for that tag 101, e.g., until the appliance 140 instructs the sensors 150 to discard the old channel estimate and replace it with the new channel estimate(s).

FIG. 5B shows how sensors 150 can distinguish changes in channel estimates caused by tag motion from changes in channel estimates caused by environmental changes, such as movement of people or fixtures 120. In FIG. 5B, a new fixture 120d has been placed between sensor 150f and tags 101g and 101j. This fixture 120d delays, attenuates, scatters, and/or blocks RF signals propagating between sensor 150f and tags 101g and 101j. These effects change the channel estimates for the communications channels 15f-g and 15f-j between sensor 150f and tags 101g and 101j, respectively, suggesting that the tags 101g and 101j have moved with respect to sensor 150f. But the communications channels 15e-g and 15e-j between sensors 150e (and sensors 150d and 150g) and tags 101g and 101j have not changed, so the channel estimates for those communications channels have not changed, suggesting that the tags 101g and 101j have not moved, at least not with respect to sensor 150c.

If sensor 150f is the only sensor whose channel estimates have changed for tags 101g and 101j, the appliance 140 can determine that the tags 101g and 101j have not moved and that the change in the channel estimates is caused by something else (here, the appearance of fixture 120d). In other words, the appliance 140 uses channel estimates from different sensors 150 for the same tag 101 corroborate whether or not changes in a particular channel estimate indicate that the tag 101 has moved. For instance, the appliance 140 can count the channel estimates as votes that the tag 101 has moved, with a minimum number or percentage of votes indicating movement. The appliance 140 can also estimate motion based on change in RSSI or Euclidean distance (in channel estimate space) between the current channel estimate(s) and historical channel estimates.

The appliance 140 can also use information about the (fixed) locations of the sensors 150 and about multiple tags 101 to distinguish tag motion from environmental changes. For example, if sensors 150 on different sides of the tag 101 all detect changes in channel estimates associated with that tag 101 (e.g., as in FIG. 5A), the appliance 140 may estimate with higher confidence that the tag 101 has moved or is moving. But if the sensors 150 on only one side of the tag 101 detect changes in channel estimates (e.g., as in FIG. 5B), then the appliance 140 may estimate that the communications channels between those sensors 150 and that tag 101 have changed but the tag 101 has not moved with respect to the sensors 150. And if the appliance 150 determines that channel estimates for a sensor 150 and several tags 101 have changed (e.g., as in FIG. 5B), then the appliance 140 may estimate that all of those tags 101 have moved or that something else has changed the corresponding communications channels depending on whether or not any of those tags' channel estimates to other sensors 150 have changed.

Generally, a sensor can read 30-40 tags during a short hop. If the sensor detects changes in most or all of the channel estimates for those tags from one hop to the next, it is highly likely that motion is changing or has changed the communications channels. Likewise, if multiple sensors detect changes in channel estimates to the same tag or group of tags, then it is highly likely that the tag or group of tags has moved or that other motion has perturbed the communication channels. Put differently, if several sensors report large perturbations to the appliance in their channel estimates for a given tag, then the appliance can determine that the tag has moved with greater confidence.

Detection of motion by multiple sensors helps to distinguish motion from noise at a particular sensor or in the communications channels. The most problematic noise and interference sources tend to be thermal noise, self-noise from the sensor's transmitter, and possible interference from other sensors. Fortunately, noise tends to have a small variance, whereas motion usually causes a large perturbation in the channel estimate. As a result, a sensor should be able to distinguish motion from noise relatively easily, especially when it averages the channel estimate over 128 symbols in the case of a tag's ACK reply, providing up to 21 dB (=10 log₁₀(128)) of processing gain. In addition, the ACK should have a signal-to-noise per bit (E_{b}/Nₒ) of >10 dB and encodes a cyclic redundancy check (CRC), which reduces the possibility of decoding errors in the tag's reply.

### Directing RFID Tag Queries Based on Detected Movement

A sensor can also query tags or switch operating modes based on or in response to changes in channel estimates detected by the RFID tag readers (sensors). For instance, consider a sensor or group of sensors that detects changes in channel estimates associated with tags in a particular area of an RFID environment. The sensor(s) can infer motion of tags, people, and/or objects in that area, particularly if corroborated by measurements from cameras or other devices that can detect motion of tags, people, and/or objects or related properties. In response to detecting motion, the sensor(s) can perform deeper scans of the affected area—for example, the sensor(s) may switch from operating in signature exploitation/consumption mode to operating in signature creation/formation mode over the affected area until motion ceases. The sensor(s) can make this switch in response to the changes in channel estimates and/or commands from an appliance, which may issue the commands in response to changes in channel estimates from other sensors or signals from cameras or other motion detectors. While in signature creation/formation mode, the sensor(s) can update channel and location estimates for the tags in the affected area. The sensor(s) also detects new tags and determines which tags, if any, have been removed from the area.

Switching modes based on detected motion or changes in channel estimates makes it possible to increase the effective tag read rate without necessarily losing information about communications channels or tags. By reading moving tags or tags in areas subject to or affected by motion more frequently, the sensors can maintain more accurate channel and location estimates. At the same time, the sensors can refrain from reading tags in areas where nothing is moving-if no motion is occurring, then the tags in that area are not moving and the communications channels between the sensors and tags should not be changing.

A sensor or group of sensors can also exploit a lack of motion to perform deep reads of an area without sufficient information about tags or communications channels. If a sensor or group of sensors determines that no motion is occurring in a particular area (e.g., from tag reads or commands from an appliance), then the sensor can perform signature creation/formation mode scans of that area as described above with respect to FIG. 3A. This may be useful if the area is in a store, warehouse, or other facility that rarely closes, never closes, or does not close for enough time to perform standard inventorying. It is also useful in a dynamic environment (e.g., an environment in which fixtures are moved) where it can be inconvenient to wait for the environment to be closed long enough for reformulating the LUT. By creating signatures for tags whenever the area is dormant or quiescent, the sensor(s) effectively extends the available signature creation time.

If the sensor determines that a tag is moving or has moved, it can estimate the tag's trajectory or likely future location(s) and either read those areas itself or trigger other sensors to read those areas, possibly via the appliance. For instance, if the tag is on an employee's badge, and the sensor detects the tag in stockroom, the sensor may begin scanning the hallway connecting the stockroom to the sales floor in anticipation of the employee's return to the sales floor. Similarly, if the sensor detects that a tag affixed to an item of clothing has moved to a dressing room, the sensor may trigger reads of the checkout area in anticipation of a customer purchasing the item of clothing after trying it on.

### Beam Steering Based on Channel Estimates

A sensor can also use channel estimates to steer a transmit (Tx) beam emitted by its antenna array to a particular tag or area: by inverting the channel estimate for a location stored in the LUT, the sensor can determine the beam parameters (sensor beamforming sector, carrier frequency, interrogation signal amplitude, and/or other degree(s) of freedom) for steering a beam to that location. In other words, each communications channel is reciprocal, meaning that the channel estimate represents the best beam steering vector for signals from the sensor to the corresponding tag location. In the simplest form, the beam steering vector is derived by inverting the phases, which is equivalent to taking the conjugate of the channel estimate. For example, if the sensor's first antenna element has a 40° phase relative to the sensor's second antenna element for a given channel estimate, the sensor should apply a −40° phase to the first antenna element relative to the second antenna element for steering a beam to the corresponding tag location. If desired, the sensor can also invert the gains (i.e., 1/gₘ, for all m antenna elements) and then normalize the amplitudes to achieve a target power level for better combining gain.

If the antenna array's gain in that direction is high enough, the sensor can transmit the signal at a lower amplitude, reducing power consumption and potentially increasing or maximizing the signal-to-interference-and-noise ratio (SINR) of the detected reply. Reducing the signal amplitude also reduces the likelihood of activating tags at nearby locations, which can reduce the amount of time it takes to query the tag at the desired location (the sensor does not have to contend with responses from other tags).

The sensor can also determine which locations in the environment lack channel estimates and steer beams towards those locations. If the channel estimates vary smoothly (e.g., as a function of sensor beamforming sector) with location, then the sensor can predict the channel estimates for the locations missing from the LUT and invert the channel estimates to determine transmission parameters for querying the missing locations. By transmitting a potentially higher-power query with those transmission parameters, the sensor may cause the tag to emit a response strong enough for the sensor to detect. This can be useful for querying and locating a tag that is present but is not producing detectable responses to broadcast queries, e.g., due to interference or multipath effects in the communications channels.

Precision of Tag Location with Channel Estimation

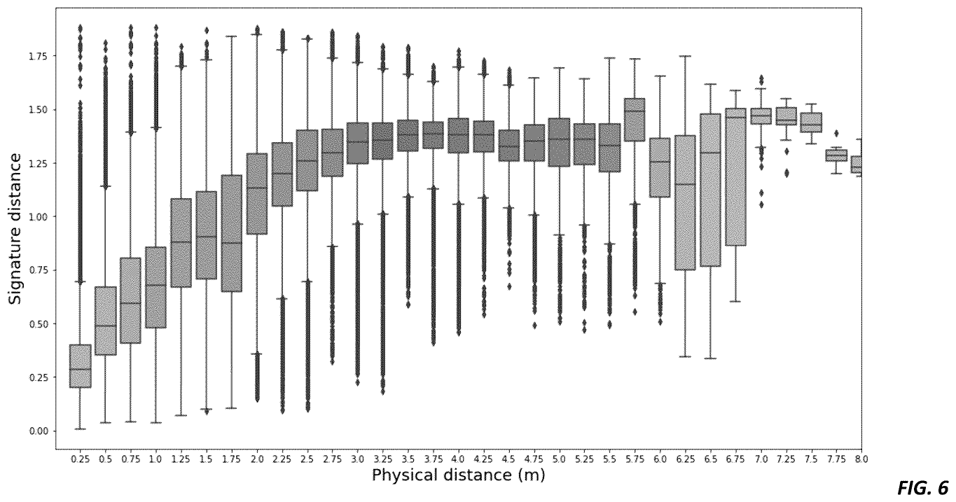

FIG. 6 is a box plot of Euclidean distance between channel estimates in channel estimate space, or signature distance, versus physical distance generated from replies from tags in a warehouse data. Each of the 32 boxes in FIG. 6 represents measurements made with the same parameters (sensor, carrier frequency, and beamforming sector). Each box was created by picking a tag (EPC) and computing its signature and physical distances to each other tag (EPC) in the same parameter group, then repeating the calculations for every other tag (EPC) in the parameter group. FIG. 6 shows that tags that are close to each other (in physical space) have similar signatures (normalized channel estimates): there is a roughly linear relationship/correlation between the tags' signature distances and physical distances up to a physical distance of about 3.5 meters. By limiting the signature match distance, it is possible to limit or predict the quality of a tag's estimated xyz position.

TABLE 2 (below) lists the errors, in meters, for different quantiles of estimated two-dimensional (2D) and three-dimensional (3D) tag positions. These errors were generated by comparing the tags' estimated positions to their ground-truth positions, which were derived using reference tags or another mechanism of knowing the tags' ground truth locations. These known locations can be mapped to the channel estimates in the LUT. These errors become the position errors when estimating tag locations based on the nearest channel estimates.

TABLE 2
Tag Positioning Error Using Channel Estimates

| | 3D (xyz) (m) | 2D (xy) (m) |
|---|---|---|
| Minimum Error | 0.01 | 0.00 |
| Quantile (0.25) | 0.04 | 0.00 |
| Quantile (0.50) | 0.14 | 0.04 |
| Quantile (0.75) | 0.41 | 0.38 |
| Quantile (0.95) | 0.98 | 0.90 |
| Quantile (0.99) | 2.04 | 2.02 |
| Maximum Error | 13.19 | 13.18 |

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for locating radio-frequency identification (RFID) tags, the system comprising:
an RFID tag reader configured to:
detect a reply from a first RFID tag,
form a first channel estimate based on the reply from the first RFID tag, the first channel estimate representing a communications channel between the RFID tag reader and the first RFID tag,
detect a reply from a second RFID tag, to form a second channel estimate based on the reply from the second RFID tag, the second channel estimate representing a communications channel between the RFID tag reader and the first RFID tag at a carrier frequency of the reply from the first RFID tag, and
perform a comparison of the second channel estimate to the first channel estimate; and
an appliance, operably coupled to the RFID tag reader, configured to:
estimate a location of the first RFID tag based on the reply from the first RFID tag,
receive the comparison of the second channel estimate to the first channel estimate from the RFID tag reader, and
estimate, based at least in part on the comparison and on the location of the first RFID tag, a location of the second RFID tag.

2. The system of claim 1, wherein the RFID tag reader comprises:
an antenna array with n antenna elements, where n is an integer greater than 1, configured to sense radiation from the first RFID tag; and
a processor, operably coupled to the antenna array, to generate, for each of the n antenna elements in the antenna array, a complex number representing a phase and an amplitude of the reply as detected at that antenna element.

3. The system of claim 1, wherein the appliance is configured to estimate the location of the first RFID tag based on an angle of arrival of the reply from the first RFID tag at the RFID tag reader.

4. The system of claim 1, wherein the appliance is configured to estimate the location of the first RFID tag based on a correlation of a location of an object or person appearing in an image with the first RFID tag.

5. The system of claim 1, wherein the RFID tag reader is configured to perform the comparison of the second channel estimate to the first channel estimate by finding a Euclidean distance between the first channel estimate and the second channel estimate.

6. The system of claim 5, wherein the RFID tag reader is configured to compare the Euclidean distance to a predetermined threshold.

7. The system of claim 1, wherein the appliance comprises:
a memory to store the location of the first RFID tag in a lookup table indexed by the first channel estimate; and
a processor, operably coupled to the memory, to retrieve the location of the first RFID tag from the lookup table based on the comparison of the second channel estimate to the first channel estimate.

8. The system of claim 7, wherein:
the RFID tag reader is configured to detect a reply from a third RFID tag, to form a third channel estimate based on the reply from the third RFID tag, the third channel estimate representing a communications channel between the RFID tag reader and the third RFID tag, and to perform a comparison of the second channel estimate to the third channel estimate; and
the appliance is configured to estimate a location of the third RFID tag based on the reply from the third RFID tag, to store the location of the third RFID tag in the lookup table indexed by the third channel estimate, and determine, based on the comparison of the second channel estimate to the third channel estimate, that the location of the second RFID tag is closer to the location of the first RFID tag than to the location of the third RFID tag.

9. The system of claim 1, wherein the reply from the first RFID tag encodes an electronic product code (EPC) of the first RFID tag and the RFID tag reader is configured to store the first channel estimate associated with the EPC of the first RFID tag in a first lookup table.

10. A method of locating radio-frequency identification (RFID) tags, the method comprising:
detecting, by an RFID tag reader, a reply from a first RFID tag;
forming a first channel estimate based on the reply from the first RFID tag, the first channel estimate representing a communications channel between the RFID tag reader and the first RFID tag at a carrier frequency of the reply from the first RFID tag;
estimating a location of the first RFID tag based on the reply from the first RFID tag;
detecting, by the RFID tag reader, a reply from a second RFID tag;
forming a second channel estimate based on the reply from the second RFID tag, the second channel estimate representing a communications channel between the RFID tag reader and the second RFID tag at a carrier frequency of the reply from the second RFID tag;
performing a comparison of the second channel estimate to the first channel estimate; and
estimating, based at least in part on the comparison and on the location of the first RFID tag, a location of the second RFID tag.

11. The method of claim 10, wherein:
detecting the reply from the first RFID tag comprises sensing radiation from the first RFID tag at each of n antenna elements, where n is an integer greater than 1, and
forming the first channel estimate comprises generating, for each of the n antenna elements, a complex number representing a phase and an amplitude of the reply as detected at that antenna element.

12. The method of claim 10, wherein estimating the location of the first RFID tag comprises determining an angle of arrival of the reply from the first RFID tag at the RFID tag reader.

13. The method of claim 10, wherein estimating the location of the first RFID tag comprises:
detecting, with a camera, an image of the first RFID tag and an object or person; and
correlating a location of the object or person with the first RFID tag.

14. The method of claim 10, wherein performing the comparison of the second channel estimate to the first channel estimate comprises finding a Euclidean distance between the first channel estimate and the second channel estimate.

15. The method of claim 14, wherein performing the comparison of the second channel estimate to the first channel estimate further comprises comparing the Euclidean distance to a predetermined threshold.

16. The method of claim 10, further comprising:
storing the location of the first RFID tag in a lookup table indexed by the first channel estimate,
wherein estimating the location of the second RFID tag comprises retrieving the location of the first RFID tag from the lookup table based on the comparison.

17. The method of claim 16, further comprising:
detecting, by the RFID tag reader, a reply from a third RFID tag;
forming a third channel estimate based on the reply from the third RFID tag, the third channel estimate representing a communications channel between the RFID tag reader and the third RFID tag;
estimating a location of the third RFID tag;
storing the location of the third RFID tag in the lookup table indexed by the third channel estimate;
performing a comparison of the second channel estimate to the third channel estimate; and
determining, based on the comparison of the second channel estimate to the third channel estimate, that the location of the second RFID tag is closer to the location of the first RFID tag than to the location of the third RFID tag.

18. The method of claim 10, wherein the reply from the first RFID tag encodes an electronic product code (EPC) of the first RFID tag, and further comprising:
associating the first channel estimate with the EPC of the first RFID tag in a first lookup table.

19. The method of claim 10, further comprising:
moving the first RFID tag after detecting the reply from the first RFID tag and before detecting the reply from the second RFID tag.

20. The method of claim 10, further comprising:
detecting, by the RFID tag reader, a reply from a third RFID tag;
forming a third channel estimate based on the reply from the third RFID tag, the third channel estimate representing a communications channel between the RFID tag reader and the third RFID tag;
performing a comparison of the third channel estimate to the first channel estimate; and
estimating, based at least in part on the comparison of the third channel estimate to the first channel estimate, a location of the third RFID tag.

21. A method of locating a radio-frequency identification (RFID) tag, the method comprising:
detecting, by an RFID tag reader, a reply from the RFID tag at a first carrier frequency and a first beamforming sector;
forming a channel estimate based on the reply from the RFID tag, the channel estimate representing a communications channel between the RFID tag reader and the RFID tag at the first carrier frequency and the first beamforming sector;
performing a comparison the channel estimate to previously determined channel estimates based on replies detected by the RFID tag reader using the first beamforming sector and/or at the first carrier frequency; and
estimating a location of the RFID tag based on a previously determined location associated with one of the previously determined channel estimates.

22. The method of claim 21, wherein comparing the channel estimate to the previously determined channel estimates comprises determining that a Euclidean distance between the channel estimate and the one of the previously determined channel estimates is below a predetermined threshold and wherein estimating the location of the RFID tag comprises estimating the location of the RFID tag to be the previously determined location.

23. The method of claim 21, wherein the previously determined channel estimates are associated with the RFID tag and wherein comparing the channel estimate to the previously determined channel estimates comprises:
retrieving the previously determined channel estimates from a memory of the RFID tag reader based on an identifier of the RFID tag encoded in the reply from the RFID tag;
comparing the channel estimate to the previously determined channel estimates; and
in response to determining that the channel estimate is within a predetermined threshold of the one of the previously determined channel estimates, estimating the location of the RFID tag to be the previously determined location associated with the one of the previously determined channel estimates.

24. The method of claim 21, further comprising:
storing previously determined locations associated with the previously determined channel estimates in a memory of the RFID tag reader.

25. The method of claim 24, wherein the previously determined locations are stored indexed by the previously determined channel estimates and/or by electronic product codes of the RFID tags.

26. A method of locating a first radio-frequency identification (RFID) tag, the method comprising:
detecting, by an RFID tag reader, replies from RFID tags at each of a plurality of carrier frequencies;
forming respective channel estimates for the RFID tags at each of the plurality of carrier frequencies;
storing, in a memory, respective locations of the RFID tags indexed by the respective channel estimates;
detecting, by the RFID tag reader, a reply from the first RFID tag at a first carrier frequency in the plurality of carrier frequencies;
forming a first channel estimate for the first RFID tag at the first carrier frequency based at least in part on the reply from the first RFID tag at the first carrier frequency;
determining a closest channel estimate to the first channel estimate from among the respective channel estimates stored in the memory;
estimating a location of the first RFID tag to be a location corresponding to the closest channel estimate; and
retrieving the location corresponding to the closest channel estimate from the memory.

27. A method comprising:
detecting, by a radio-frequency identification (RFID) tag reader at a first time, a first reply from an RFID tag;
forming a first channel estimate for a communications channel between the RFID tag and the RFID tag reader based on the first reply;
detecting, by the RFID tag reader at a second time after the first time, a second reply from the RFID tag;
forming a second channel estimate for the communications channel between the RFID tag and the RFID tag reader based on the second reply;
determining that the second channel estimate differs from the first channel estimate by more than a predetermined amount; and
in response to determining that the second channel estimate differs from the first channel estimate by more than the predetermined amount, determining that motion has affected the communications channel.

28. The method of claim 27, wherein that the motion is movement of the RFID tag.

29. The method of claim 27, wherein that the motion is movement of at least one of an object other than the RFID tag or a person.

30. The method of claim 27, further comprising:
determining a first estimated location for the RFID tag based on the first channel estimate; and
determining a second estimated location different than the first estimated location for the RFID tag based on the second channel estimate.

31. A method of detecting motion, the method comprising:
detecting a change in a communications channel between a first radio-frequency identification (RFID) tag and an RFID tag reader;
detecting a change in a communications channel between a second RFID tag and the RFID tag reader; and
determining, based on the changes in the communications channels, that motion has occurred in an area encompassing at least a portion of the communications channels.

32. The method of claim 31, wherein detecting the change in the communications channel comprises:
detecting a change in relative phase of radio-frequency radiation received by antenna elements of the RFID tag reader from the first RFID tag.

33. The method of claim 31, further comprising:
in response to determining that the motion has occurred, forming channel estimates, by the RFID tag reader, for at least one other RFID tag.

34. The method of claim 31, further comprising:
in response to determining that the motion has occurred, switching an operating mode of the RFID tag reader.

35. A method of locating a first radio-frequency identification (RFID) tag, the method comprising:
determining, by an RFID tag reader, a channel estimate for a communications channel between the RFID tag reader and the first RFID tag;
performing, by the RFID tag reader, a comparison of the channel estimate to a previously determined channel estimate for the first RFID tag;
in response to the channel estimate being within a threshold of the previously determined channel estimate, estimating a location of the first RFID tag to be a previously estimated location for the first RFID tag; and
in response to the channel estimate being more than the threshold away from the previously determined channel estimate:
determining that the channel estimate is within the threshold of a previously determined channel estimate for a second RFID tag; and
identifying the location of the first RFID tag be a previously estimated location of the second RFID tag.

36. A system for locating a radio-frequency identification (RFID) tag, the system comprising:
an RFID tag reader to determine a channel estimate of a communications channel between the RFID tag reader and the RFID tag, to perform a comparison of the channel estimate to a previously determined channel estimate for the RFID tag, and to determine whether or not the RFID tag moved since the RFID tag reader determined the previously determined channel estimate; and
a controller, operably coupled to RFID tag reader, to receive an identifier for the RFID tag and an indication of whether or not the RFID tag moved from the RFID tag reader and to estimate a location of the RFID tag based on the identifier and the indication.

37. The system of claim 36, wherein the identifier is an Electronic Product Code (EPC) of the RFID tag.

38. The system of claim 36, wherein the controller comprises a memory storing previously determined locations for a plurality of RFID tags indexed by identifiers of the plurality of RFID tags.
